(19) United States
(12) Patent Application Publication
(10) Pub. No.: US 2019/0244111 A1
(43) Pub. Date: Aug. 8, 2019

(54) AVOIDING DEAD ENDS IN REAL-TIME HEURISTIC SEARCH

(71) Applicant: University of New Hampshire, Durham, NH (US)

(72) Inventors: Wheeler Ruml, Durham, NH (US); Bence Cserna, Durham, NH (US); William Doyle, Durham, NH (US); Jordan Ramsdell, Durham, NH (US)

(73) Assignee: University of New Hampshire, Durham, NH (US)

(21) Appl. No.: 16/266,806

(22) Filed: Feb. 4, 2019

Related U.S. Application Data
(60) Provisional application No. 62/625,529, filed on Feb. 2, 2018.

(51) Int. Cl. G06N 5/00

(52) U.S. Cl. CPC G06N 5/003

(57) ABSTRACT

A system that avoids dead-end states during a real-time heuristic search. While transitioning from a previous state to a current state, the system may perform lookahead to populate a state-space with potential states. The system may identify safe states using a safety predicate and only select potential states that are ancestors of safe states, providing a clear path to safety when needed. In addition, the system may determine a distance-to-safety function that indicates a number of state transitions between each potential state and a nearest safe state.

### CROSS-REFERENCE TO RELATED APPLICATION DATA

This application claims the benefit of priority of, U.S. Provisional Patent Application No. 62/625,529, filed Feb. 2, 2018, and entitled “AVOIDING DEAD ENDS IN REAL-TIME HEURISTIC SEARCH,” in the names of Wheeler Ruml, et al. The above provisional application is herein incorporated by reference in its entirety.

### BACKGROUND

Many systems, such as mobile robots, need to be controlled in real time. Real-time heuristic search is a popular planning paradigm that supports concurrent planning and execution.

### BRIEF DESCRIPTION OF DRAWINGS

For a more complete understanding of the present disclosure, reference is now made to the following description taken in conjunction with the accompanying drawings.

FIGS. 1A-1B illustrate a system for determining decisions to avoid dead end states during a real-time heuristic search according to embodiments of the present disclosure.

FIGS. 2A-2C illustrate examples of decision trees with different amounts of look-ahead data.

FIG. 3 illustrates examples of a dead-end state and a safety-loop state.

FIGS. 4A-4D illustrate examples of identifying potential nodes, a target node, safe nodes, and comfortable nodes according to embodiments of the present disclosure.

FIGS. 5A-5C illustrate examples of filtering potential nodes based on safety according to embodiments of the present disclosure.

FIG. 6 illustrates an example of committing to a single action or multiple actions according to embodiments of the present disclosure.

FIG. 7 illustrates examples of different safety algorithms to identify a path to a goal according to embodiments of the present disclosure.

FIGS. 8A-8B are flowcharts conceptually illustrating example methods for generating a decision tree and selecting a decision according to embodiments of the present disclosure.

FIGS. 9A-9C illustrate an example method for expanding a decision tree and selecting a decision according to embodiments of the present disclosure.

FIG. 10 is a flowchart conceptually illustrating an example method for allocating processing resources between node expansion based on a safety predicate and node expansion based on a cost function according to embodiments of the present disclosure.

FIG. 11 illustrates examples of success rates for different algorithms according to embodiments of the present disclosure.

FIGS. 12A-12B illustrate examples of goal achievement times and average velocity values for different algorithms according to embodiments of the present disclosure.

FIG. 13 is a block diagram conceptually illustrating example components of a system according to embodiments of the present disclosure.

### DETAILED DESCRIPTION

Many systems, such as mobile robots, need to be controlled in real time. Real-time heuristic search is a popular planning paradigm that supports concurrent planning and execution. However, existing methods do not incorporate a notion of safety and perform poorly in domains that include dead-end states from which a goal cannot be reached.

To improve an ability to reach the goal, devices, systems and methods are disclosed that use new real-time heuristic search methods that can guarantee safety if the domain obeys certain properties. For example, the system may identify safe nodes that correspond to safe states and select potential nodes that are ancestors of safe nodes, providing a clear path to safety when needed. In addition, the system may determine a distance-to-safety function that indicates a number of state transitions between each potential node and a nearest safe node.

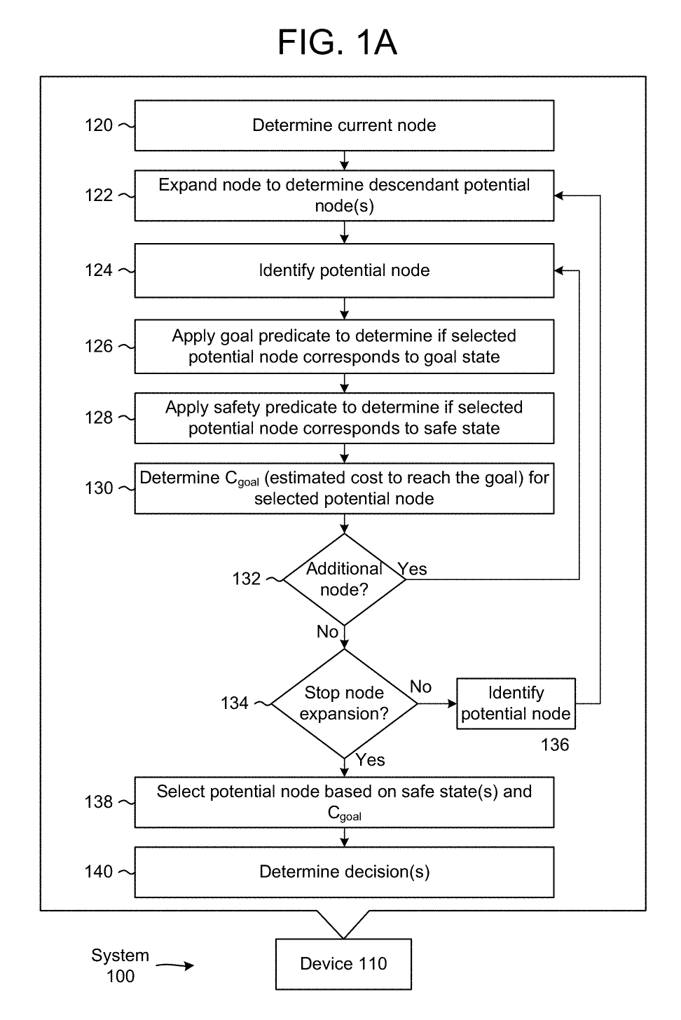

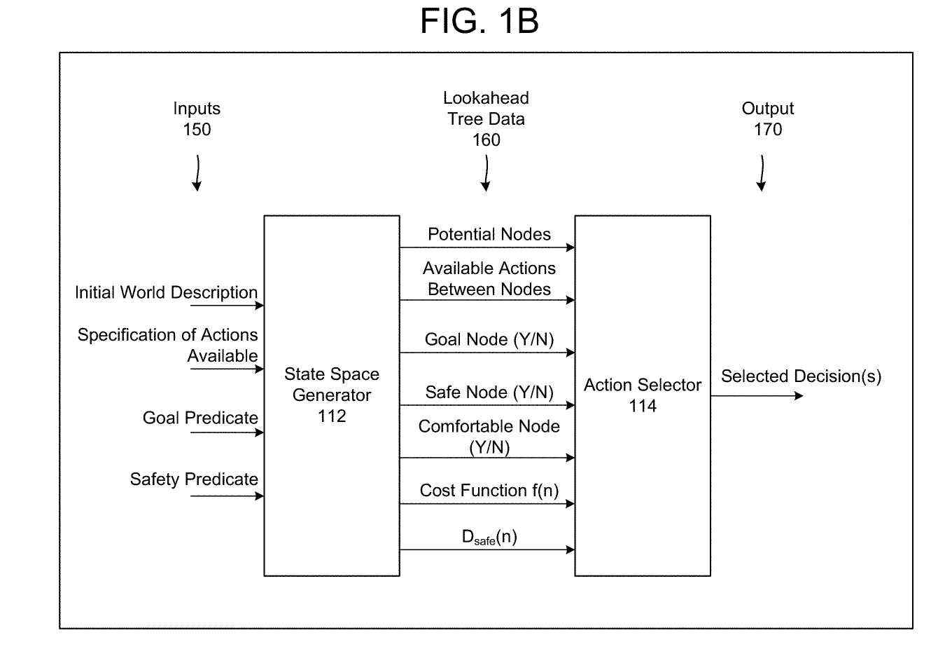

FIGS. 1A-1B illustrate a system for determining decisions to avoid dead end states during a real-time heuristic search according to embodiments of the present disclosure. As illustrated in FIG. 1A, a system 100 may include a device 110, which may be any electronic device that includes one or more processors. For example, the device 110 may correspond to a mobile robot, an autonomous vehicle, a spacecraft, or the like. The system 100 may be configured to perform real-time heuristic search to reach a goal state by identifying and selecting potential nodes while prioritizing safety of the system 100 (e.g., improving an ability to reach the goal state).

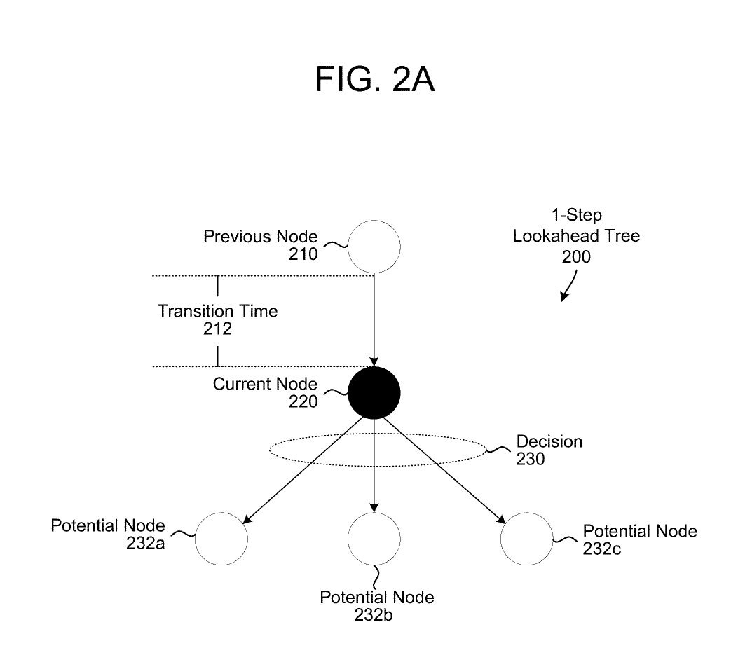

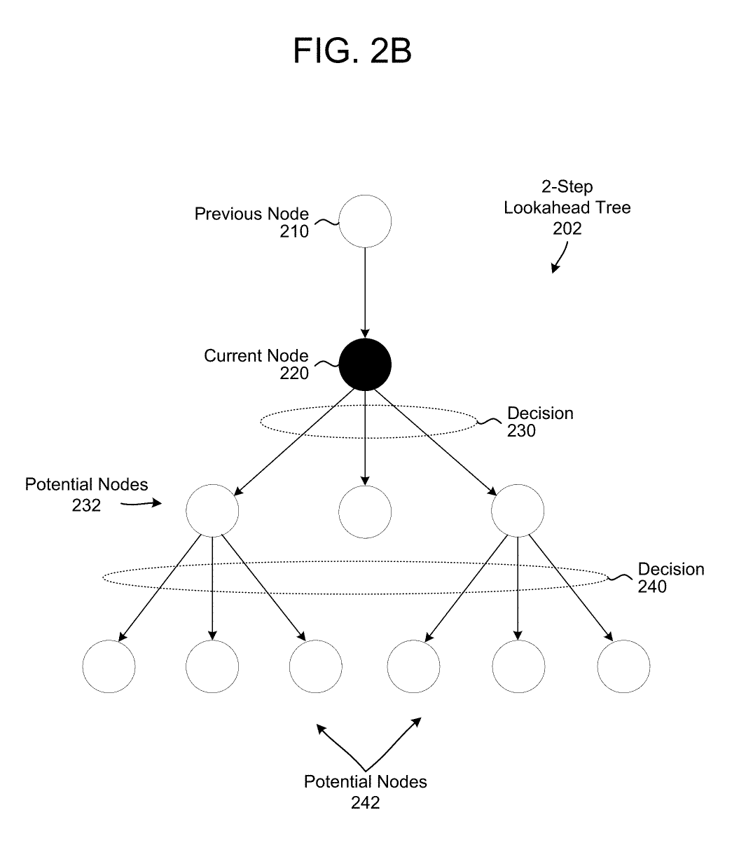

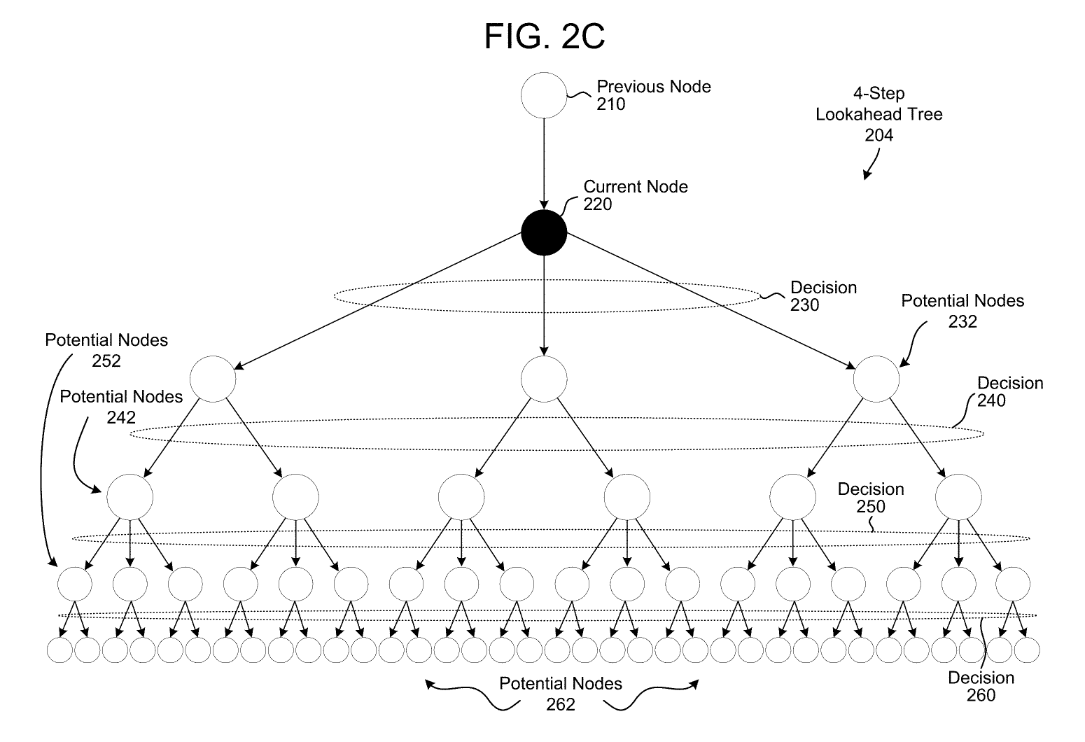

FIGS. 2A-2C illustrate examples of decision trees with different amounts of look-ahead data. As illustrated in FIG. 2A, a system 100 may transition from a previous node 210 to a current node 220, and the time spent transitioning from the previous node 210 to the current node 220 may be referred to as a transition time 212. During the transition time 212, the system 100 may plan ahead and determine what potential nodes 232 are available after the current node 220 and make a decision 230 as to which action to take (e.g., which potential node 232 to select). For example, FIG. 2A illustrates a 1-step lookahead tree 200 that only includes the immediate subsequent potential nodes 232; a first potential node 232a, a second potential node 232b, and a third potential node 232c. Regardless of what future nodes are available (e.g., distant potential nodes), the system 100 must select one of the potential nodes 232 (e.g., proximate potential nodes), and the decision 230 corresponds to the action the system 100 must take to transition to the selected potential node 232.

The time spent planning before the next action must be determined may be referred to as a “lookahead period.” As used herein, “lookahead” may be interchangeable with “look ahead,” “look-ahead,” and/or other variations of the spelling without departing from the disclosure. During the lookahead period, the system 100 may identify potential nodes by populating a state-space (e.g., solution space) and expanding nodes in the state-space. The state-space (e.g., state space or the like) models a set of states that the system 100 may be in over time, with each node of the state-space corresponding to a potential state of the system 100. For example, a particular node in the state-space may correspond to a potential state, such that node expansion corresponds to identifying descendant potential states and corresponding potential nodes in the state-space for the particular node (e.g., children of the particular node). A visual representation of the state-space may be referred to as a space-state graph, and “state-space” and “state-space graph” may be used interchangeably without departing from the disclosure. The state-space may include a large number of potential nodes, so to improve efficiency the system 100 may reduce the effective size of the state-space or employ a real-time heuristic search to efficiently explore the state-space within the transition time 212.

The nodes in the state-space may correspond to data structures used to organize the potential states in the state-space, and an individual node may indicate one of the potential states along with additional information about the particular node. Typically, the additional information may include an indication of a parent node (e.g., previous node), children node(s) (e.g., potential nodes to which to transition), whether the corresponding state is a goal state (e.g., desired outcome or destination state), a cost function f(n) (e.g., a cost-so far g(n) and/or an estimate of a cost-to-go value h(n) that indicates an estimated cost to reach the goal state) associated with the node, and/or the like. Thus, the system 100 may use the additional information to organize the potential nodes in a decision tree corresponding to the state-space. As the system 100 may take different paths between the potential states, multiple potential nodes may be associated with a single potential state. However, the cost function f(n) increases as the system 100 takes an action and therefore the cost function values may vary between the multiple potential nodes.

In addition to the additional information mentioned above, the system 100 may be configured to generate and store safety information corresponding to the potential nodes. For example, the system 100 may also determine whether the corresponding state is a safety state (e.g., state from which the goal state is likely reachable) and/or may determine a safety function value (e.g., distance-to-safety D_{safe}, which may be measured as a number of state transitions between the potential node and a safe state) associated with the node.

As a breadth-first search of the state-space may quickly consume all the memory/processing capabilities of a device, in some examples the system 100 may set a specific lookahead parameter (e.g., k-step lookahead limit) that specifies how deeply the state-space is explored. For example, a 1-step lookahead tree 200 is illustrated in FIG. 2A, a 2-step lookahead tree 202 is illustrated in FIG. 2B, and a 4-step lookahead tree 204 is illustrated in FIG. 2C. By setting a specific lookahead parameter, the system may carefully control an amount of processing time spent during the lookahead period, as a processing time increases exponentially as the lookahead parameter increases. While the lookahead parameter specifies how deeply the state-space is explored (e.g., how many decision steps are included in the lookahead tree), the system 100 may not expand every node within the state-space. Instead, the system 100 may eliminate entire subtrees of the state-space and/or focus node expansion on certain subtrees based on the cost function f(n) metric and/or the distance-to-safety metric, which will be described in greater detail below. Therefore, the lookahead parameter may not be precisely defined but may instead correspond to a maximum depth searched, an average depth searched, a maximum number of nodes generated, or the like without departing from the disclosure.

An amount of time associated with populating the state-space and/or expanding nodes within the state-space is dependent on hardware characteristics of the system (e.g., processing speed, amount of memory, etc.). For simplicity and reproducibility, time is measured using node expansions throughout this disclosure. For example, a shorter lookahead period would correspond to fewer node expansions than a longer lookahead period.

As used herein, lookahead data corresponds to potential nodes in the state-space, such as potential nodes 232 in the 1-step lookahead tree 200 illustrated in FIG. 2A. As mentioned above, the 1-step lookahead tree 200 includes the previous node 210, the current node 220, and the potential nodes 232a-232c. As described above, each of the nodes may correspond to a potential state of the system 100. Once the system 100 determines which of the potential nodes 232a-232c to select, the system 100 may determine the decision 230 corresponding to the selected potential node.

Similarly, the 2-step lookahead tree 202 illustrated in FIG. 2B includes the previous node 210, the current node 220, a first layer of potential nodes 232 and a second layer of potential nodes 242. As illustrated in FIG. 2B, a first decision 230 corresponds to a first action associated with the potential node 232 selected by the system 100 and a second decision 240 corresponds to a second action associated with the potential node 242 selected by the system 100.

Finally, the 4-step lookahead tree 204 illustrated in FIG. 2C includes the previous node 210, the current node 220, a first layer of potential nodes 232, a second layer of potential nodes 242, a third layer of potential nodes 252, and a fourth layer of potential nodes 252. As illustrated in FIG. 2C, a first decision 230 corresponds to a first action associated with the potential node 232 selected by the system 100, a second decision 240 corresponds to a second action associated with the potential node 242 selected by the system 100, a third decision 250 corresponds to a third action associated with the potential node 252 selected by the system 100, and a fourth decision 260 corresponds to a fourth action associated with the potential node 262 selected by the system 100.

While FIGS. 2A-2C only illustrate up to a 4-step lookahead tree (e.g., lookahead parameter k=4), this is for ease of illustration only and the disclosure is not limited thereto. Instead, the system 100 may have a lookahead parameter ranging from 4 to 10,000 or even higher without departing from the disclosure.

Due to a limited period of time associated with the transition time 212, the system 100 is often under time pressure, needing to solve a large problem in a limited amount of time. For example, an autonomous vehicle interacts with other vehicles and pedestrians, as well as stationary objects, and must identify potential nodes and determine a decision in real-time. As the system 100 may have a limited amount of time to plan, the system 100 may take actions towards the goal (e.g., selecting intermediary nodes towards the goal) without having enough time to make a complete plan to reach all the way to the goal. Therefore, there is a risk that the system 100 takes actions that may not only be sub-optimal (e.g., there are more efficient paths to the goal that require less time), but may be dangerous. For example, an autonomous vehicle making decisions during run-time could be unable to plan far enough ahead to see an obstacle (e.g., brick wall) and therefore may be unable to avoid hitting the obstacle and crashing. In this context, colliding with the obstacle may correspond to a dead-end state as we assume that the autonomous vehicle is severely damaged from the collision and therefore unable to proceed towards the goal.

As used herein, a dead-end state corresponds to an infeasible state (e.g., crash state) in which there are no options to proceed toward the goal (e.g., no potential states available). Additionally or alternatively, a dead-end state may correspond to a feasible state (e.g., potential states available that may proceed toward the goal) but may be a state to which the system 100 is not allowed to enter. For example, a potential state may correspond to an illegal action (e.g., making a U-turn) or may be excluded based on user preferences associated with the user (e.g., avoiding toll highways, avoiding routes that pass a particular location, such as a particular store, bridge, highway or the like). Thus, the dead-end state is not an infeasible state for all users, but the system 100 may consider the dead-end state infeasible based on the current user preferences, device settings, system settings or the like.

In contrast to a dead-end state, a safe state is a state in which the system 100 is safe (e.g., still likely to reach the goal state). In some examples, a safe state may correspond to complete safety (e.g., no likelihood of reaching a dead-end state), such as being parked in a garage with the garage door closed or something similar. However, the disclosure is not limited thereto and in some examples the system 100 may identify a safe state without the safe state having a guarantee that the goal is reachable. For example, a safe state for an autonomous vehicle may correspond to being parked on the side of the road, whereas a safe state for a spacecraft may correspond to all hatches being closed and all instruments protected. Thus, the system 100 may remain likely to reach the goal while in the safe state, although this is not guaranteed (e.g., another vehicle may collide with the autonomous vehicle despite the autonomous vehicle being parked on the side of the road).

In some examples, the system 100 may be programmed with one or more safe states explicitly determined. However, this may be impractical during real-time processing, so the system 100 may instead be configured to identify that a certain potential state is a safe state based on conditions of the potential state or the like without departing from the disclosure. For example, the system 100 may generate the state-space and identify that certain potential states correspond to a safe state. Thus, the disclosure is not limited to safe states being explicitly determined prior to run-time. Instead, a safety predicate used by the system 100 may correspond to a heuristic technique that is not guaranteed to be optimal.

To illustrate an example, the system 100 may propagate the state-space with potential nodes. For each potential node, the system 100 may determine whether the potential node corresponds to a goal state (e.g., desired state or destination) and/or a safety state (e.g., state from which the goal state is likely reachable). For example, the system 100 may input a selected state to a first Boolean function, which may generate a binary value indicating whether the selected state corresponds to a goal state (e.g., output of True indicating that the selected state is a goal state, output of False indicating that the selected state is not a goal state). Additionally or alternatively, the system 100 may input the selected state to a second Boolean function, which may generate a binary value indicating whether the selected state corresponds to a safe state (e.g., output of True indicating that the selected state is a safe state, output of False indicating that the selected state is not a safe state). In the example of an autonomous vehicle, the system 100 may use a set of criteria for the safety predicate (e.g., “Is the vehicle stopped?”, “Is the vehicle at the side of the road?”, and/or the like) and when each of the criteria are satisfied, the system 100 may determine that the selected state corresponds to a safe state. Thus, the safety predicate may be programmed based on what task the search algorithm is trying to solve.

To reduce a likelihood that the system 100 reaches a dead-end state, the system 100 may maintain a feasible plan to reach a safe state in case other potential nodes being considered turn out to be dead ends. As used herein, a potential node that corresponds to a safe state or that is known to have a safe descendant (e.g., node 1 is not a safe state, but leads to node 2 which is a safe state) may be referred to as a comfortable node, and an action leading to a comfortable node may be referred to as a safe action. Thus, the system 100 may prioritize safety (e.g., increase likelihood of reaching the goal) if the system 100 never goes to an uncomfortable node (e.g., a node corresponding to a state that is not known to be a safe state or known to have a safe descendent). In contrast, a potential node with no known safe descendants may be referred to as an unsafe node, although determining unsafety may be impractical (e.g., there may be safe descendent not identified by the system 100).

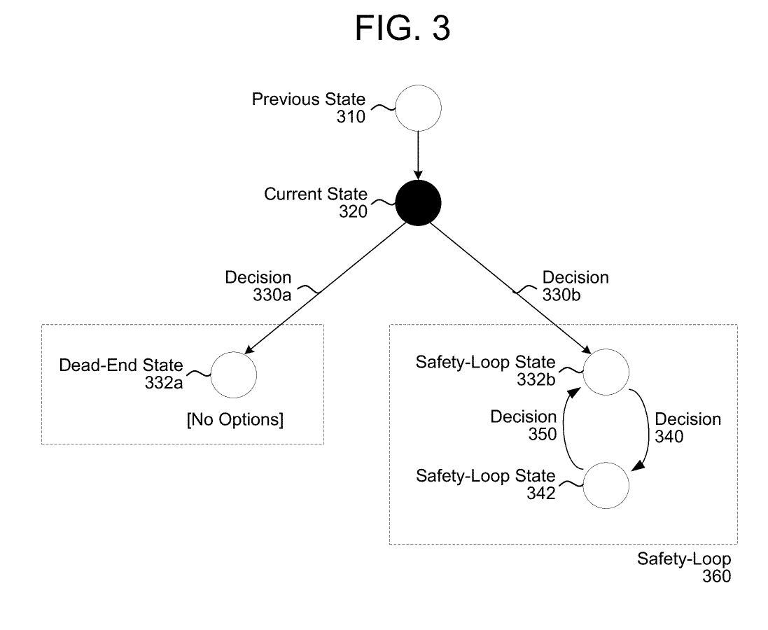

FIG. 3 illustrates examples of a dead-end state and a safety-loop. In the example described above, the autonomous vehicle crashing corresponds to a dead-end state as there are no options available to the system 100 (e.g., no descendant potential nodes). For example, FIG. 3 illustrates a previous state 310, a current state 320 and a dead-end state 332a, which has no descendent potential states. If the system 100 made a first decision 330a to select the dead-end state 332a before realizing that there are no descendent potential states, the system 100 would be stuck in the dead-end state 332a with no way of reaching the goal.

While the system 100 is configured to prioritize safe actions and maintain safety, the system 100 is not configured to prioritize goal reachability. In some examples, the system 100 may select safe actions and remain in comfortable states without being able to reach the goal. This may be referred to as a safety-loop, as the system 100 may determine descendant potential actions to select but may be stuck in a loop transitioning between the same potential states repeatedly. For example, the autonomous vehicle may have limited lookahead (e.g., small lookahead parameter), resulting in the system 100 reaching a safety-loop and being unable to navigate across a bridge. To illustrate a simplified example, the system 100 may only be able to plan two steps ahead (e.g., lookahead parameter k equal to 2) and therefore may only identify one safe state (e.g., pulling off the road before crossing the bridge), which results in the autonomous vehicle repeatedly pulling on the road and then pulling off the road again. While the system 100 is stuck in the safety-loop, the system 100 has not reached a dead-end state as the system 100 is safe and has descendant potential states from which to choose (e.g., pulling on and off the road).

FIG. 3 illustrates the system 100 entering a safety-loop 360. As illustrated in FIG. 3, the safety-loop 360 may correspond to alternating between a first safety-loop state 332b and a second safety-loop state 342. For example, the system 100 may make a second decision 330b to transition to the first safety-loop state 332b, from which the system 100 alternates between making a decision 340 to transition to the second safety-loop state 342 and a decision 350 to transition back to the first safety-loop state 332b. If the system 100 makes the second decision 330b to select the first safety-loop state 332b, the system 100 may continue to identify potential states but be unable to reach the goal. As illustrated in the safety-loop 360, while the system 100 remains safe and does not enter an unsafe state, the system 100 is now stuck in a loop between the first safety-loop state 332b and the second safety-loop state 342 and is unable to advance towards the goal. However, this is a unique situation caused by limited lookahead data. The system 100 may prioritize reaching the goal state when there are multiple safe nodes, such as by selecting the comfortable node having a lowest estimated cost.

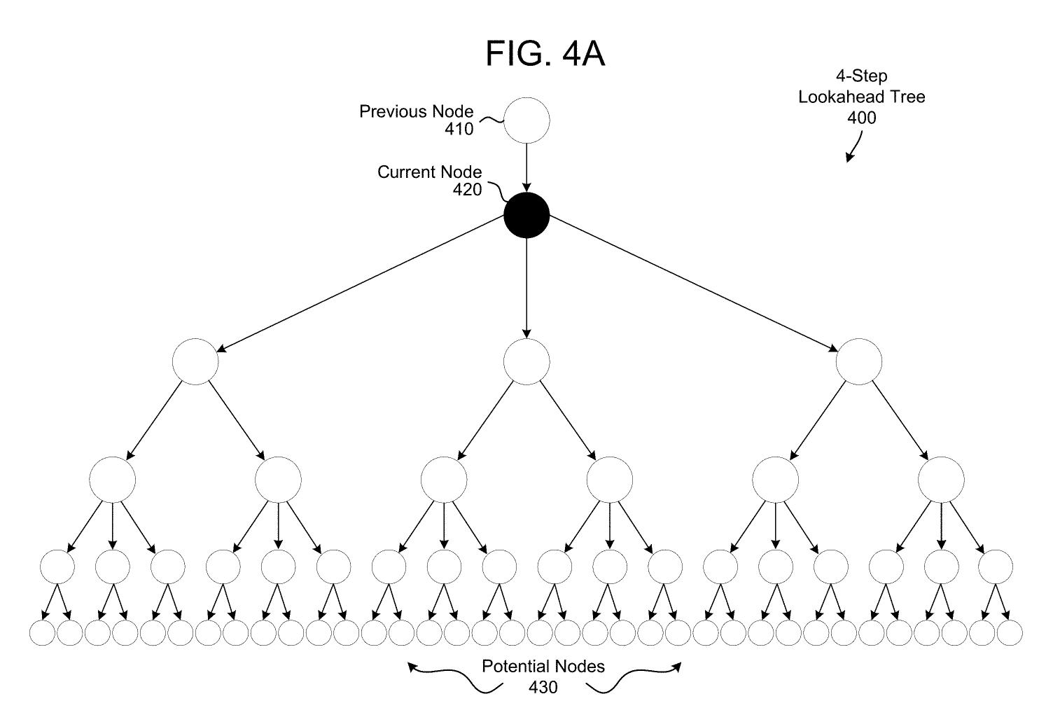

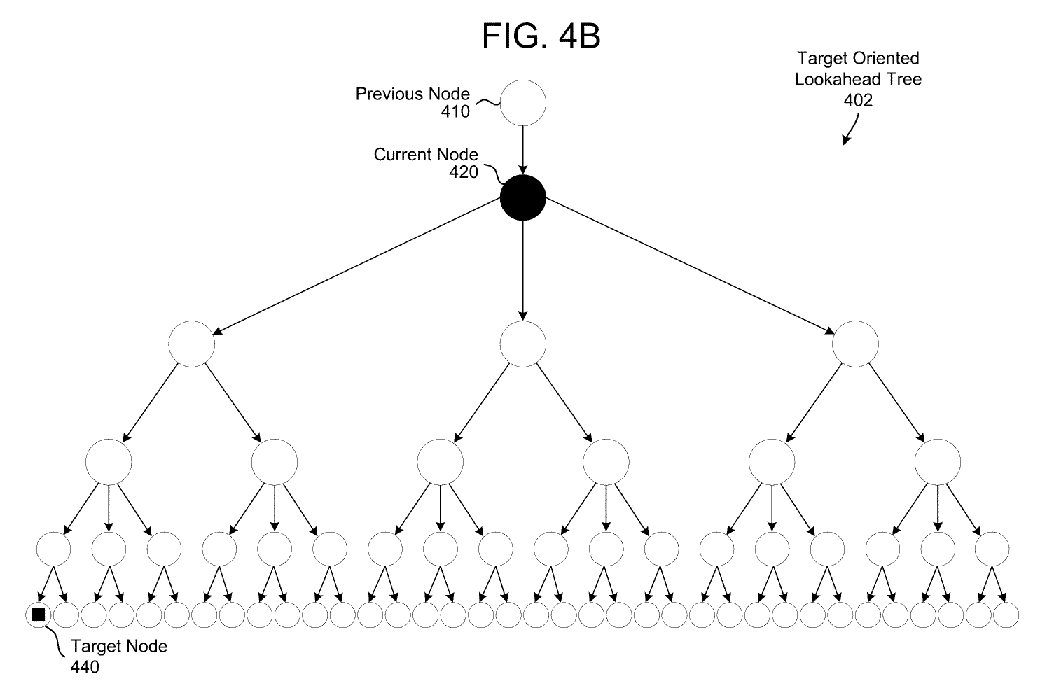

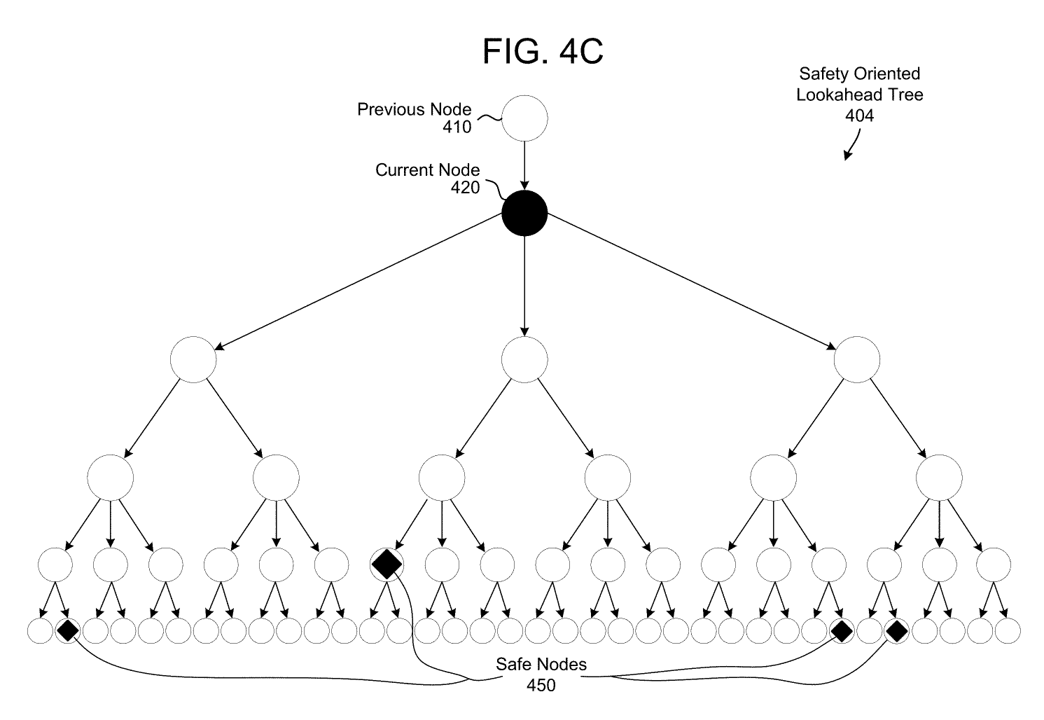

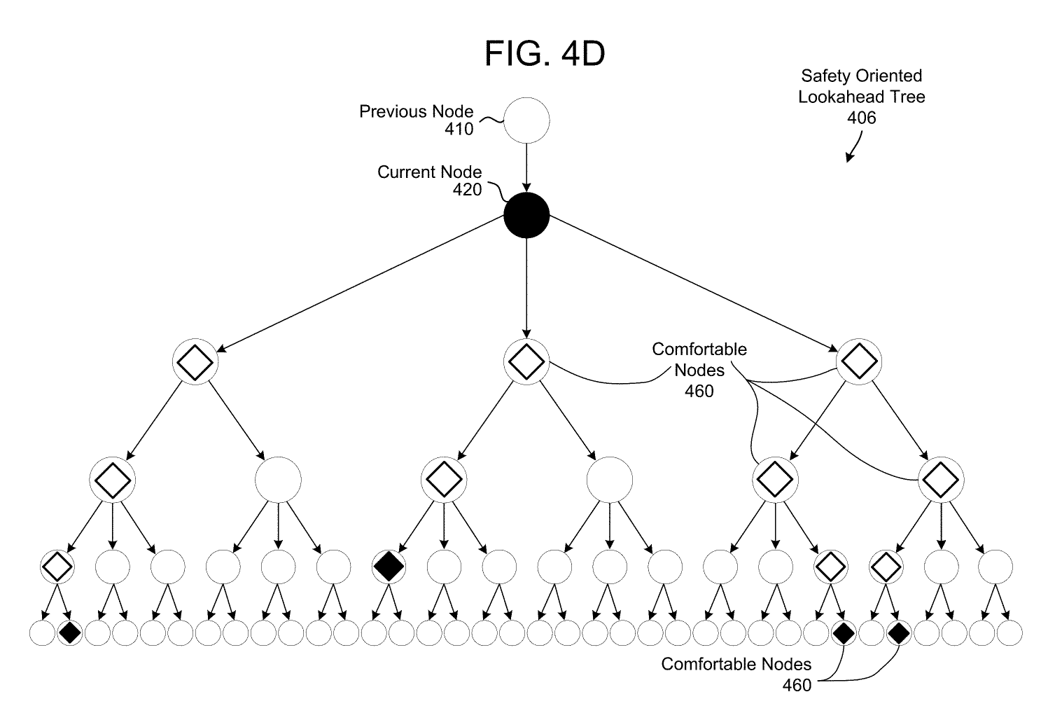

FIGS. 4A-4D illustrate examples of identifying potential nodes, a target node, safe nodes, and comfortable nodes according to embodiments of the present disclosure. As illustrated in FIG. 4A, a 4-step lookahead tree 400 may include a previous node 410, a current node 420, and potential nodes 430, which may include 3 potential nodes in a first layer, 6 potential nodes in a second layer, 18 potential nodes in a third layer, and/or 36 potential nodes in a fourth layer. Each of the nodes in the 4-step lookahead tree 400 are indicated by a circle, with the current node 420 indicated by a filled circle whereas the previous node 410 and the potential nodes 430 are indicated by unfilled circles. While the 4-step lookahead tree 400 illustrates the potential nodes 430 being relatively symmetrical, this is intended for ease of illustration and the disclosure is not limited thereto. Instead, a number of descendent potential nodes may vary for each of the potential nodes without departing from the disclosure. In addition, while FIG. 4A illustrates the 4-step lookahead tree 400 expanding each of the potential nodes 430 down to the fourth layer, the disclosure is not limited thereto and the system 100 may perform node expansion on only a portion of the potential nodes 430 based on cost function f(n) values.

The system 100 may be configured to identify potential nodes 430 that have lowest cost function f(n) values, and in some examples the system 100 may identify a node on an edge of the lookahead tree (e.g., fourth layer) having a lowest cost function f(n) value of the potential nodes 430 as a target node 440. For example, FIG. 4B illustrates a target oriented lookahead tree 402 that includes a target node 440, which is indicated by a filled square inside of a circle. The system 100 may determine a cost function f(n) for each of the potential nodes 430, which may be equal to a sum of a cost-so-far value g(n) and an estimate of a cost-to-go value h(n) for a given node n (e.g., f(n)=g(n)+h(n)). For example, the device would determine a cost function f(n) for each of the potential nodes 430 and then select the potential node 430 having the lowest cost function f(n) value as the target node 440. In a conventional system, the device would select the target node 440 and perform a series of actions to proceed to the target node 440 due to the target node 440 having the lowest estimated cost value of the potential nodes 430.

To prioritize safety, the system 100 of the present invention may add a safety constraint and select between the potential nodes 430 based on safe state(s) and/or a distance-to-safety function d_{safe}(n). For example, FIG. 4C illustrates a safety oriented lookahead tree 404 that includes four safe nodes 450, with the safe nodes 450 indicated by a filled diamond inside of a circle. After identifying the safe nodes 450, the system 100 may select all ancestor nodes of the safe nodes 450 and identify both the ancestor nodes and the safe nodes 450 as comfortable nodes 460. Thus, each of the comfortable nodes 460 is either a safe node 450 or is located along a path to a safe node 450 (e.g., if necessary, the system 100 may take safe actions to reach a safe node 450). FIG. 4D illustrates a safety oriented lookahead tree 406 that indicates the comfortable nodes 460 corresponding to the safe nodes 450, with the comfortable nodes 460 indicated by an unfilled diamond inside of a circle.

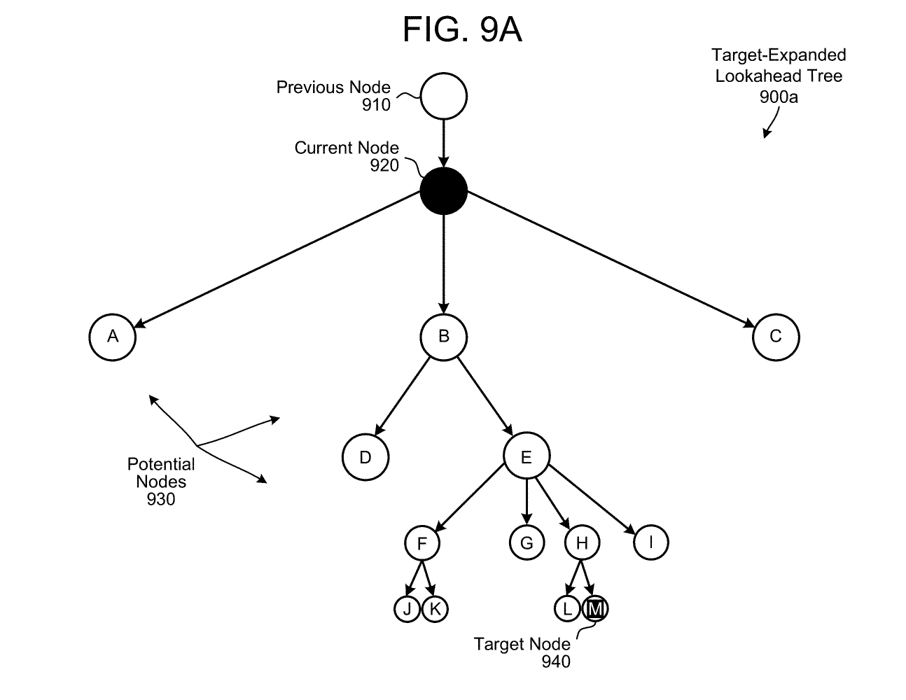

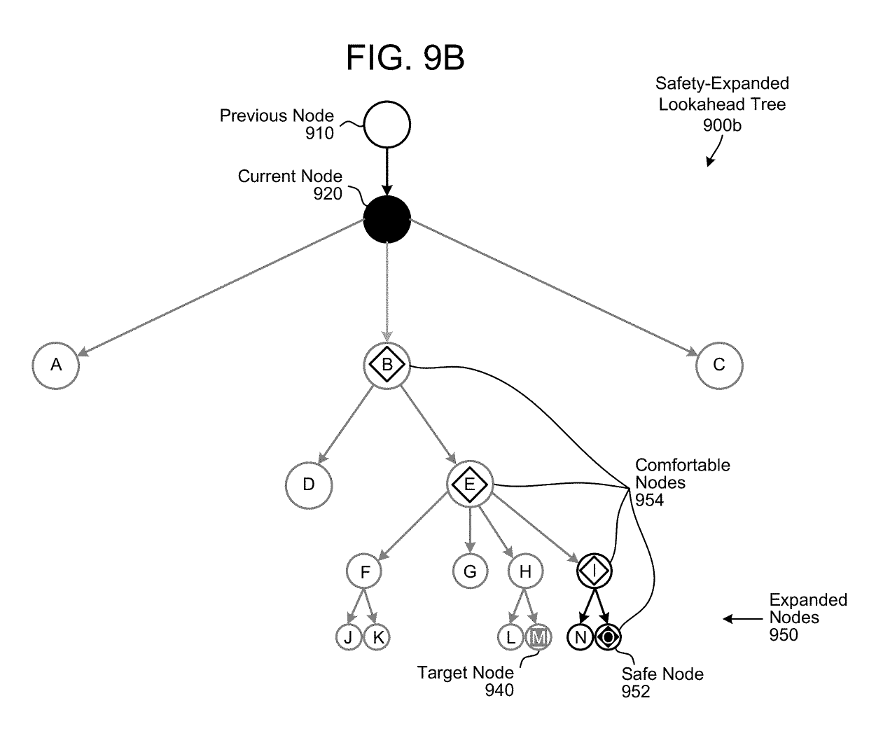

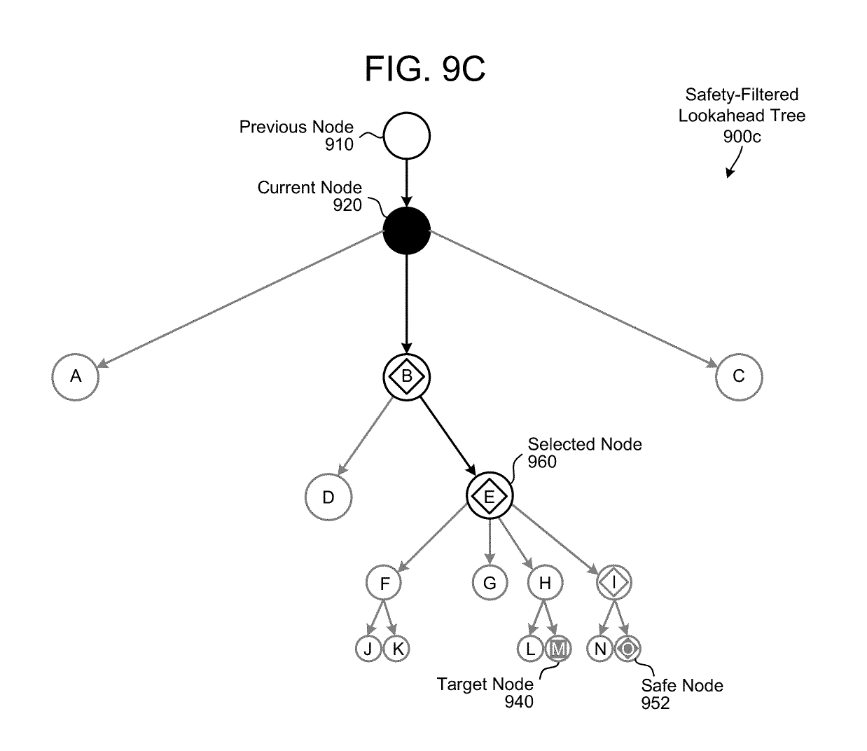

To prioritize safety, the system 100 may only select potential nodes 430 that correspond to the comfortable nodes 460. Therefore, unlike the conventional system, the system 100 would not select the target node 440 if the target node 440 does not correspond to a comfortable node 460, despite the target node 440 having a lowest estimated cost value of the potential nodes 430. Instead, the system 100 may select a comfortable node 460 that is an ancestor to the target node 440 and/or identify a second target node having a second-lowest estimated cost value and determine whether the second target node is a comfortable node 460, as will be described in greater detail below with regard to FIGS. 9A-9C.

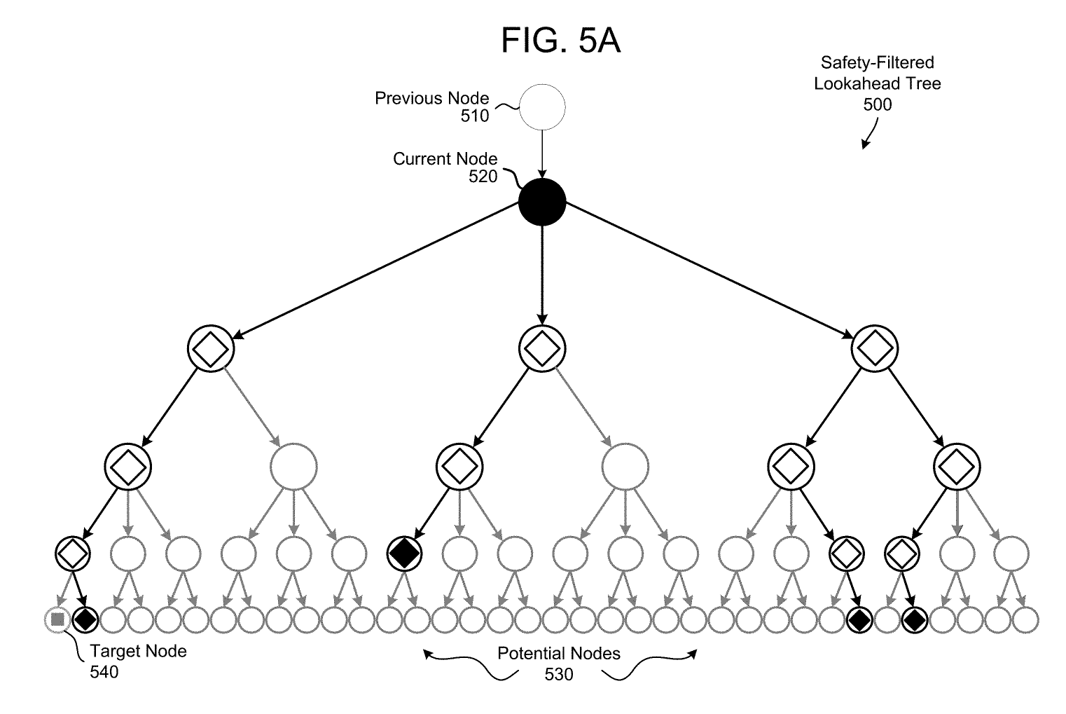

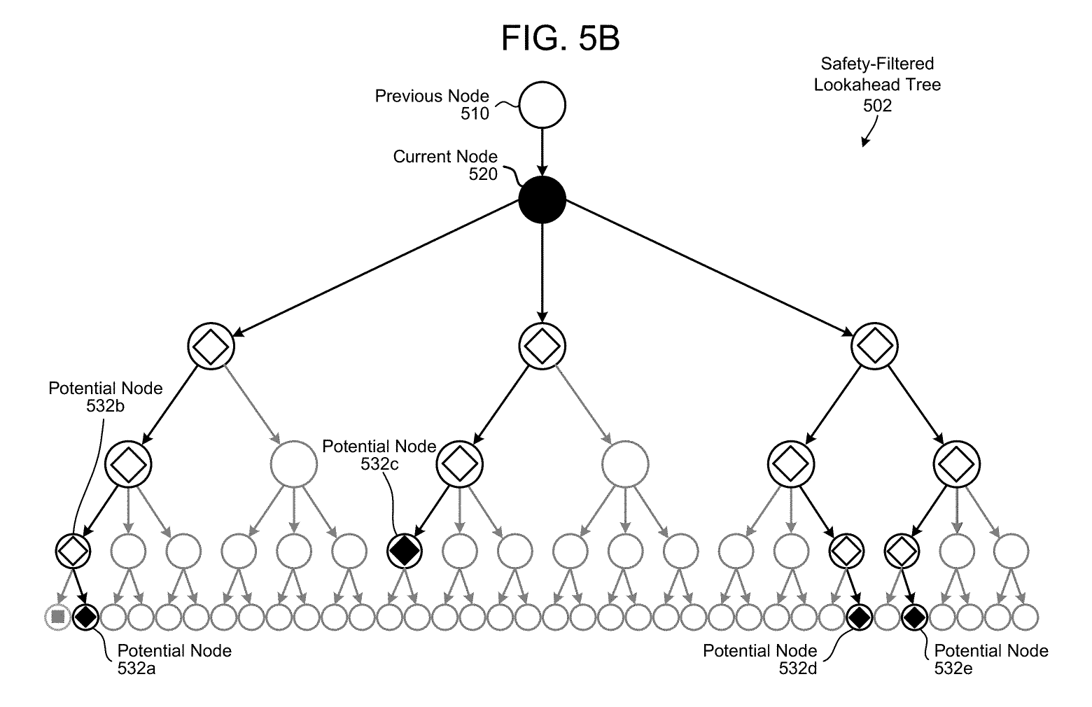

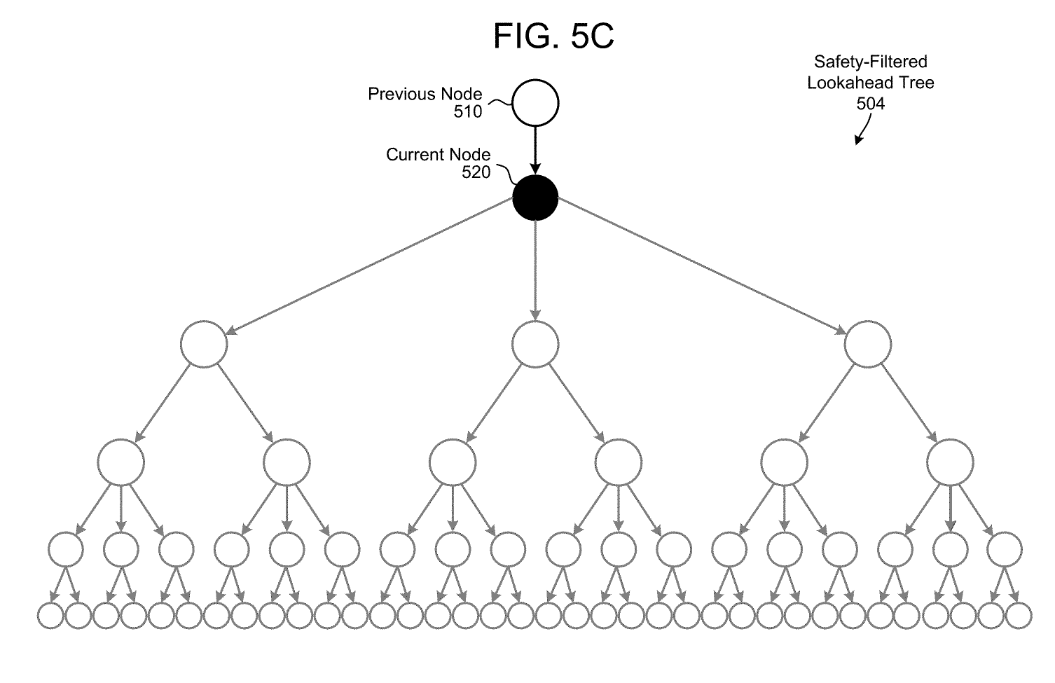

FIGS. 5A-5C illustrate examples of filtering potential nodes based on safety according to embodiments of the present disclosure. As used herein, filtering refers to selecting between potential nodes based on one or more characteristics of the potential nodes. For example, filtering distance-to-safety D_{safe}(n) values based on a threshold value corresponds to only selecting amongst potential nodes that have a distance-to-safety value below the threshold value. However, the system 100 may maintain and store information regarding all of the potential nodes and does not necessarily discard potential states/potential nodes that do not satisfy the filtering metric value (e.g., distance-to-safety threshold value). For example, FIG. 5A illustrates a safety-filtered lookahead tree 500 that includes a previous node 510, a current node 520, and potential nodes 530. As illustrated in FIG. 5A, the safety-filtered lookahead tree 500 filters (e.g., removes from consideration while storing and maintaining associated information) any potential nodes 530 that are not comfortable nodes. Thus, the system 100 may only select a potential node 530 that is a comfortable node.

The system 100 may select a potential node 530 from the safety-filtered lookahead tree 500 based on the estimated cost values. For example, the system 100 may identify potential nodes 530 that are comfortable nodes (e.g., safe nodes 450 and/or ancestors to the safe nodes 450) and may optionally identify a target node 540 having a lowest estimated cost value of the potential nodes 530. As illustrated in safety-filtered lookahead tree 502 in FIG. 5B, the system 100 may select between comfortable nodes such as a first potential node 532a, a second potential node 532b, a third potential node 532c, a fourth potential node 532d, and/or a fifth potential node 532e. Each of the potential nodes 532a-532e correspond to comfortable nodes (e.g., the first potential node 532a corresponds to a first safe node, the second potential node 532b corresponds to a parent of the first safe node, the third potential node 532c corresponds to a second safe node, the fourth potential node 532d corresponds to a third safe node, and the fifth potential node 532e corresponds to a fourth safe node.)

As illustrated by the safety-and-goal-filtered lookahead tree 502, the target node 540 does not correspond to a comfortable node. Therefore, the system 100 will not decide to transition to the target node 540, despite the target node 540 having a lowest estimated cost value of the potential nodes 530. However, in some examples the system 100 may transition to the nearest comfortable ancestor of the target node 540 (e.g., the nearest ancestor to the target node 540 that is a comfortable node). For example, the system 100 may determine that the first potential node 532a is a safe node and may backtrack to determine that the second potential node 532b is both a comfortable node and an ancestor of the target node 540. Therefore, the system 100 may transition to the second potential node 532b and perform additional lookahead during the transition period.

While in some examples the system 100 may transition to the nearest ancestor to the target node 540, the disclosure is not limited thereto. Instead, the system 100 may identify a second target node having a second-lowest estimated cost value and determine whether the second target node is a comfortable node. If the second target node is a comfortable node (e.g., fourth potential node 532d), the system 100 may transition to the second target node (e.g., fourth potential node 532d) instead of transitioning to the nearest ancestor (e.g., second potential node 532b) of the target node 540.

The system 100 is not limited to identifying a target node and may instead determine the lowest estimated cost of all of the comfortable nodes, including comfortable nodes in the first layer or the second layer of the safety-filtered lookahead tree 502. Additionally or alternatively, the system 100 may select a potential node 530 that has the lowest estimated cost value from comfortable nodes in the first layer without departing from the disclosure. As another example, the system 100 may select a potential node 530 that has a lowest estimated cost value of all of the safe nodes of the safety-filtered lookahead tree 502. In some examples, the system 100 may identify potential nodes 530 having a distance-to-safety D_{safe}(n) value below a threshold value and may select a potential node 530 that has a lowest estimated cost value of the identified potential nodes 530. Thus, the system 100 may select between the potential nodes 530 based on the cost function f(n), the safe nodes, the comfortable nodes, and/or the distance-to-safety D_{safe}(n) function without departing from the disclosure.

FIG. 5C illustrates an example of the system 100 determining that none of the potential nodes 530 correspond to comfortable nodes. As illustrated in FIG. 5C, a safety-filtered lookahead tree 504 includes no safe nodes, which results in no comfortable nodes from which to choose. In this situation, the system 100 may choose to remain at the current node 520, if possible, while expanding the lookahead to find safe state(s). For example, by increasing the lookahead parameter or expanding additional nodes, the system 100 may increase a depth of the safety-filtered lookahead tree 504 and identify at least one comfortable node.

As illustrated in FIG. 1A, the system 100 may determine (120) a current node and may expand (122) the node to determine descendant potential node(s). For example, the system 100 may determine potential actions available and potential nodes corresponding to each of the potential actions. The system 100 may identify (124) a potential node (e.g., a first child node), may apply (126) a goal predicate to determine if the identified potential node corresponds to a goal state, may apply (128) a safety predicate to determine if the identified potential node corresponds to a safe state, and may determine (130) a cost function f(n) value (e.g., C_{goal}) that indicates an estimated cost to reach the goal for the identified potential node.

The system 100 may determine (132) whether there was an additional potential node during the previous node expansion and if so, may loop to step 124 to identify the potential node and repeat steps 126-130 for the identified potential node. If there are no additional potential nodes, the system 100 may determine (134) whether to stop node expansion (e.g., if a lookahead time period has elapsed) and, if not, may identify (136) a potential node to expand and may loop to step 122 and repeat steps 122-134 for the identified potential node. Thus, the system 100 may continue to propagate a state-space (e.g., solution space) with potential nodes. For example, the system 100 may determine a state-space graph that includes the current node and the potential nodes.

During step 130, the system 100 may determine the cost function f(n) values that indicate an estimated cost to reach the goal associated with each of the potential nodes. The cost function f(n) is a sum of a cost-so-far function g(n) and an estimated cost-to-go function h(n) (e.g., f(n)=g(n)+h(n)). For example, a cost function value associated with a first potential node corresponds to a sum of a first estimated cost between the current node and the first potential node and a second estimated cost between the first potential node and the goal, with a lower cost function value indicating a more efficient path to the goal. If the first potential state node has no descendant goal nodes, the first cost function f(n)value is set equal to an extremely large number (e.g., infinity ∞).

In some examples, the system 100 may determine distance-to-safety values using a distance-to-safety function d_{safe}(n) for each of the potential nodes. For example, a first distance-to-safety value associated with the first potential node indicates a second number of state transitions between the potential node 430a and a nearest safe node. Thus, a safe node corresponds to a distance-to-safety value of zero, parent of a safe node correspond to a distance-to-safety value of one, grandparent of a safe node correspond to a distance-to-safety value of two, and so on. If the first potential node has no descendant safe nodes, the first distance-to-safety value is set equal to an extremely large number (e.g., infinity ∞).

The system 100 may select (138) a potential node based on the safe state(s) and cost function f(n) value (e.g., C_{goal}) and may determine (140) decision(s) corresponding to the selected potential node.

In some examples, the system 100 may select the potential node based on the distance-to-safety values. For example, the system 100 may filter the potential nodes based on the distance-to-safety values d_{safe}(n). As used herein, filtering the potential nodes corresponds to removing from consideration potential nodes that have a distance-to-safety value above a threshold value. For example, if the threshold value is set to 5, the system 100 may remove from consideration the potential nodes that do not have a known ancestor safe node within 5 state transitions (e.g., unsafe nodes) and leave the comfortable nodes with a known ancestor safe node less than 5 state transitions away. However, this is just an example and the disclosure is not limited thereto.

FIG. 1B illustrates example components of the system 100 as well as inputs 150 and outputs 170 of the search algorithm. As illustrated in FIG. 1B, the device 110 may include a state space generator 112 that is configured to receive the inputs 150 and generate lookahead tree data 160 (e.g., propagate a state-space). The device 110 may also include an action selector 114 that is configured to receive the lookahead tree data 160 and select one or more decision(s) as the output 170.

The inputs 150 may include a variety of information, such as an initial world description of an environment associated with the system 100, a specification of actions available to the system 100 (e.g., what actions the system 100 may perform), a goal predicate, and a safety predicate. The state space generator 112 may generate the lookahead tree data 160 by propagating the state-space data with potential nodes. For each potential node, the state space generator 112 may determine information about a parent node, available actions between the potential node and children node(s) (e.g., which actions are available to that specific node), information about children node(s), whether the potential node corresponds to a goal state (e.g., using the goal predicate), whether the potential node corresponds to a safe state (e.g., using the safety predicate), whether the potential node corresponds to a comfortable node (e.g., a descendant node correspond to a safe state), an estimated cost value (e.g., using the cost function f(n)) associated with the potential node, a distance-to-safety value (e.g., D_{safe}) associated with the potential node, and/or the like. Thus, the lookahead tree data 160 encapsulates all of the information associated with the potential nodes that will be beneficial in selecting an action.

The action selector 114 may receive the lookahead tree data 160 and perform the techniques described herein to select a potential node to which to transition the system 100. The system 100 may then determine selected decision(s) that correspond to transitioning to the selected potential node (e.g., committing to one or more actions corresponding to the potential node).

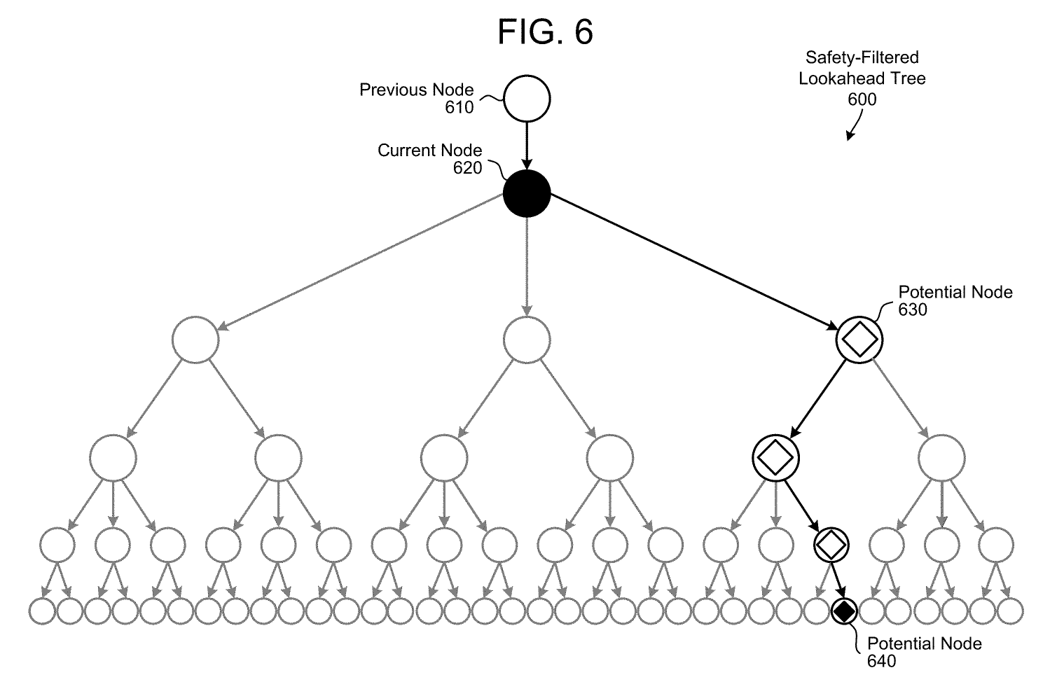

FIG. 6 illustrates an example of committing to a single action or multiple actions according to embodiments of the present disclosure. As illustrated in FIG. 6, a safety-filtered lookahead tree 600 may include a previous node 610, a current node 620, and a plurality of potential nodes including a first potential node 630 and a second potential node 640. For example, the second potential node 640 may correspond to a safe state and the first potential node 630 may be an ancestor of the second potential node 640. Thus, the first potential node 630 is a child of the current node 620 (e.g., 1 step below), whereas the second potential node 640 is a great-great-grandchild of the current node 620 (e.g., 4 steps below). Therefore, the system 100 may determine whether to commit to a single step at a time (e.g., select the first potential node 630) or commit to a deepest comfortable node (e.g., select the second potential node 640).

If an environment around the system 100 isn't changing too fast (e.g., the lookahead tree is still valid for a long period of time), the system 100 may determine that the second potential node 640 will still be feasible by the time the system 100 reaches it and may commit to the second potential node 640. This advances the system 100 further down the lookahead tree and provides a longer lookahead period for additional planning while the system 100 transitions to the second potential node 640. However, if the environment is changing rapidly (e.g., the lookahead tree is only valid for a short period of time), the system 100 may commit to a single step at a time (e.g., select only the first potential node 630) to avoid risks associated with outdated data caused by the changing environment.

To illustrate an example, an autonomous vehicle separated from other vehicles on a flat stretch of highway (e.g., relatively static environment) may commit to a series of lane changes (e.g., select the second potential node 640). While the system 100 transitions to the second potential node 640, the system 100 may perform additional lookahead to identify additional potential nodes that stem from the second potential node 640. However, while the system 100 may identify a series of lane changes based on current positions/velocities of vehicles on a highway, if the autonomous vehicle is surrounded by other vehicles on a curving stretch of highway (e.g., relatively dynamic environment), the system 100 may commit to a single step at a time (e.g., select the first potential node 630) and may reevaluate the potential nodes while transitioning to the first potential node 630. Thus, the system 100 may avoid committing to a potential node that may change due to the dynamic environment.

While many of the examples described above illustrate identifying comfortable nodes that include all ancestors of safe nodes and filtering based on the comfortable nodes, the disclosure is not limited thereto. Instead, the system 100 may determine a distance-to-safety d_{safe}(n) value for each node n and may filter based on the distance-to-safety d_{safe}(n) values. For example, a first potential node may be 3 state transitions (e.g., 3 steps away) from a descendant safe node, whereas a second potential node may be 6 state transitions (e.g., 6 steps away) from a descendant safe node. If the system 100 filters the potential nodes based on a distance-to-safety threshold value of 4, the system 100 may identify that the first potential node is a comfortable node (e.g., distance-to-safety value of 3 is below the threshold value of 4), whereas the second potential node is an unsafe node (e.g., distance-to-safety value of 6 is above the threshold value of 4). Therefore, the system 100 would not consider the second potential node, despite it having a descendant safe node. Additionally or alternatively, the system 100 may select the potential node based on a combination of the cost function f(n) values and the distance-to-safety d_{safe}(n) values without departing from the disclosure.

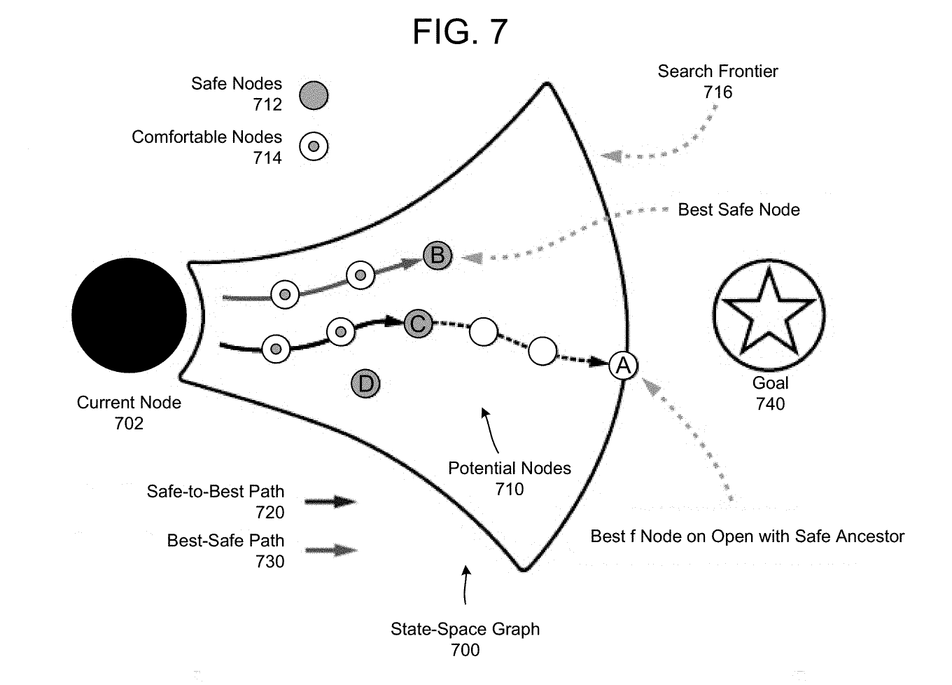

FIG. 7 illustrates examples of different safety algorithms to identify a path to a goal according to embodiments of the present disclosure. As illustrated in FIG. 7, the system 100 may generate a state-space graph 700 that includes a current node 702 and potential nodes 710 that extend up to a search frontier 716 (e.g., deepest lookahead data available) towards a goal 740. The system 100 may select from the potential nodes 710 within the state-space graph 700 using at least two different safety algorithms (e.g., action selection strategies). For example, a first safety algorithm (e.g., “safe-toward-best”) is configured to work backward from the search frontier 716 to generate a safe-to-best path 720, whereas a second safety algorithm (e.g., “best-safe”) is configured to work forward towards the search frontier 716 to generate a best-safe path 730.

As illustrated in FIG. 7, the system 100 may begin at the current node 702 and may identify potential nodes 710 (e.g., corresponding to descendant potential states) expanding outward from the current node 702 towards the goal 740. Based on how far ahead the system 100 may plan, the current state-space (e.g., search space) extends until the search frontier 716. As the search frontier 716 does not extend far enough to include the goal 740, the system 100 must select between potential nodes 710 within the search frontier 716 without complete lookahead data. The system 100 may identify that one of the potential nodes 710 is a target node (e.g., potential node having a lowest estimated cost value on the search frontier 716), such as Node A, and/or safe nodes 712 (e.g., safe states), such as Nodes B-D. After identifying the safe nodes 712, the system 100 may identify all ancestor nodes as comfortable nodes 714. For example, as Node B and Node C are safe nodes 712, the four ancestor nodes are indicated as comfortable nodes 714.

As discussed above, the first safety algorithm (e.g., “safe-toward-best”) is configured to work backward from the search frontier 716 to generate the safe-to-best path 720. For example, the system 100 may identify the target node (e.g., Node A) and determine which of the potential nodes 710 is a safe ancestor of the target node (e.g., the target node is a descendant of a safe node 712). The system 100 may determine a cost function value for each of the potential nodes 710 using a cost function f(n), which is a sum of a cost-so-far function g(n) and an estimated cost-to-go function h(n) (e.g., f(n)=g(n)+h(n)). For example, a cost function value associated with Node A indicates an estimated cost to reach the goal 740 using Node A, with a lower estimated cost value indicating a more efficient path to the goal 740. To generate the safe-to-best path 720, the system 100 may determine that Node A has a lowest estimated cost value of the potential nodes 710 on the search frontier 716 with a safe ancestor and work backwards to identify comfortable nodes 714 that extend from the current node 702 to Node A.

In contrast, the second safety algorithm (e.g., “best-safe”) is configured to work forward towards the search frontier 716 to generate the best-safe path 730. Thus, the system 100 may identify the potential nodes 710, the safe nodes 712, and/or the comfortable nodes 714, and may select a series of comfortable node 714 to transition the system 100 towards the goal 740. In some examples, the system 100 may select the comfortable nodes 714 having a lowest estimated cost function value f(n). However, the disclosure is not limited thereto and in other examples, the system 100 may select the comfortable nodes 714 based on a combination of the cost function value f(n) and/or a distance-to-safety value d_{safe}(n), which indicates a number of state transitions between the selected node n and a nearest safe node 712. For example, the system 100 may filter the comfortable nodes 714 using a threshold value, may determine the comfortable nodes 714 having a lowest distance-to-safety value d_{safe}(n), a lowest cost function value f(n) with the distance-to-safety value d_{safe}(n) used as a tiebreaker, a lowest sum of the cost function value f(n) and the distance-to-safety value d_{safe}(n), and/or the like.

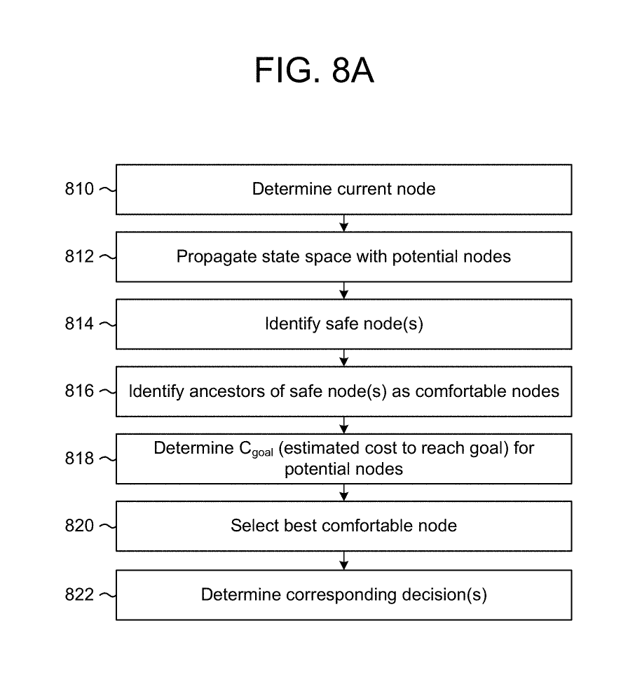

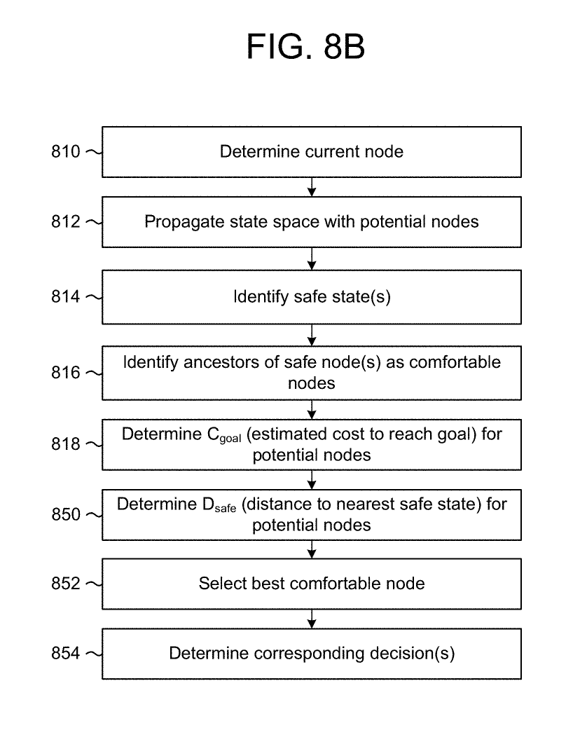

FIG. 8A is a flowchart conceptually illustrating an example method for generating a decision tree and selecting a decision according to embodiments of the present disclosure. As illustrated in FIG. 8A, the system 100 may determine (810) a current node and may propagate (812) a state-space with potential nodes. As part of propagating the state-space, the system 100 may identify (814) safe node(s), may identify (816) ancestors of the safe node(s) as comfortable nodes. For example, the system 100 may determine that some of the potential nodes correspond to a safe state and may identify all ancestors as comfortable nodes.

The system 100 may determine (818) an estimated cost to reach the goal (e.g., C_{goal}) using a cost function f(n) for each of the potential nodes. The system 100 may determine the estimated cost values for each of the potential nodes using a cost function f(n), which is a sum of a cost-so-far function g(n) and an estimated cost-to-go function h(n) (e.g., f(n)=g(n)+h(n)). For example, a first estimated cost value associated with a first potential node indicates a first estimated cost to reach the goal. If the first potential state node has no descendant goal nodes, the first cost function f(n)value is set equal to an extremely large number (e.g., infinity CO.

Based on the estimated cost values, the system 100 may then select (820) a best comfortable node and determine (822) one or more decision(s) corresponding to the best comfortable node.

As illustrated in FIG. 8B, the system 100 may determine (810) a current node and may propagate (812) a state-space with potential nodes. As part of propagating the state-space, the system 100 may identify (814) safe node(s), may identify (816) ancestors of the safe node(s) as comfortable nodes. For example, the system 100 may determine that some of the potential nodes correspond to a safe state and may identify all ancestors as comfortable nodes. The system 100 may determine (818) an estimated cost to reach the goal (e.g., C_{goal}) using a cost function f(n) for each of the potential nodes.

In addition, the system 100 may determine (850) distance-to-safety values using a distance-to-safety function d_{safe}(n) for each of the potential nodes. For example, a first distance-to-safety value associated with the first potential node indicates a first number of state transitions between the potential node and a nearest safe node. Thus, a safe node corresponds to a distance-to-safety value of zero, children of a safe node correspond to a distance-to-safety value of one, grandchildren of a safe node correspond to a distance-to-safety value of two, and so on. If the first potential node has no descendant safe nodes, the first distance-to-safety value is set equal to an extremely large number (e.g., infinity ∞).

Based on the estimated cost values and/or the distance-to-safety values, the system 100 may then select (852) a best comfortable node and determine (854) one or more decision(s) corresponding to the best comfortable node. In some examples, the system 100 may select the best comfortable node using a distance-to-safety threshold value, although the disclosure is not limited thereto.

FIGS. 9A-9C illustrate an example method for expanding a decision tree and selecting a decision according to embodiments of the present disclosure. As illustrated in FIG. 9A, a target-expanded lookahead tree 900a may include a previous node 910, a current node 920, and a plurality of potential nodes 930. In contrast to the lookahead trees illustrated in previous drawings, FIG. 9A illustrates an asymmetrical lookahead tree that expands nodes based on a cost function f(n). For example, the system 100 may expand the current node 920 to identify three potential nodes 930 (e.g., Nodes A-C), may determine an estimated cost value for each of the three potential nodes 930, and may determine that Node B has the lowest estimated cost value. The system 100 may then repeat this process, expanding the Node B to identify two potential nodes 930 (e.g., Nodes D-E), determining an estimated cost value for each of the two potential nodes 930, and determining that Node E has the lowest estimated cost value. After performing multiple iterations of this, the system 100 may reach an edge of the target-expanded lookahead tree 900a and may identify Node M as a target node 940 that has a lowest estimated cost value of the potential nodes 930.

As discussed above, a conventional system would select the target node 940 and perform a series of actions to proceed to the target node 940 due to the target node 940 having the lowest estimated cost value of the potential nodes 930. However, the system 100 may prioritize safety and only select potential nodes 930 that correspond to comfortable nodes. During node expansion of the potential nodes 930, the system 100 may use a safety predicate to determine whether each of the potential nodes 930 corresponds to a safe state. As illustrated in FIG. 9A, however, none of the potential nodes 930 included in the target-expanded lookahead tree 900a correspond to a safe state.

Therefore, the system 100 may perform additional node expansion based on the safety predicate to identify additional nodes descending from the potential nodes 930, identify which of the additional nodes corresponds to a safe node, and determine which of the potential nodes 930 is an ancestor to at least one of the safe node(s). For example, the system 100 may expand Node I to identify two expanded nodes 950 (e.g., Nodes N-O), determine that Node O corresponds to a safe state, and identify Node O as a safe node 952, as illustrated by safety-expanded lookahead tree 900b in FIG. 9B. After identifying the safe node 952, the system 100 may identify Node O, Node I, Node E, and Node B as comfortable nodes 954.

FIG. 9C illustrates a safety-filtered lookahead tree 900c indicating the potential node 930 selected by the system 100. For example, as the target node 940 is not a comfortable node, the system 100 will not select the target node 940. However, the system 100 may determine that Node E is a comfortable node and is an ancestor of the target node 940 and may select Node E as a selected node 960 to which the system 100 will transition. Thus, the system 100 will transition to the selected node 960 and perform additional lookahead to identify a path beyond the target node 940. If the additional lookahead identifies that the target node 940 is a comfortable node (e.g., a descendant of the target node 940 is a safe node), the system 100 may transition to the target node 940 and beyond. However, if the additional lookahead does not identify that the target node 940 is a comfortable node, the system 100 may identify an alternative target node (e.g., second lowest estimated cost value) that is a comfortable node and/or transition towards the safe node 952 (e.g., transition to Node I).

While FIG. 9C illustrates an example of the system 100 determining the target node 940 and transitioning towards the target node 940 (e.g., transitioning to Node E) while maintaining a path to a safe node (e.g., stopping at Node E due to the fork between the target node 940 and the safe node 952), the disclosure is not limited thereto. Instead, the system 100 may select between safe nodes based on the estimated cost value or the like. In some examples, the expanded nodes 950 are not associated with the potential nodes 930 and are treated separately by the system 100 for purposes of future node expansion.

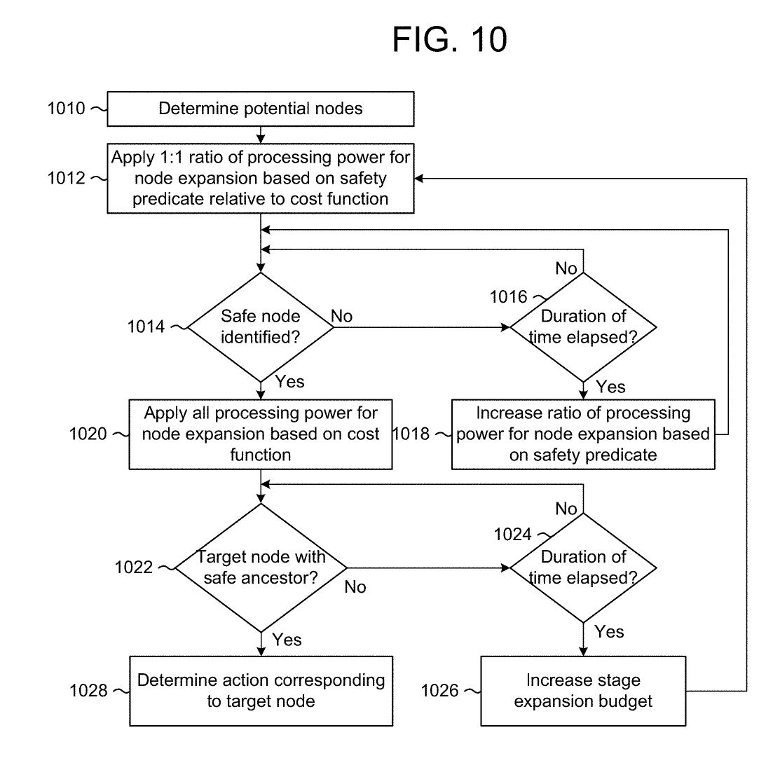

FIG. 10 is a flowchart conceptually illustrating an example method for allocating processing resources between node expansion based on a safety predicate and node expansion based on a cost function according to embodiments of the present disclosure. Node expansion based on a cost function (e.g., exploration stage of node expansion) corresponds to identifying first potential nodes that have a low estimated cost value and performing node expansion (e.g., determining descendant nodes) on the first potential nodes. Thus, while the state-space may include a large number of potential nodes, the system 100 may prioritize expanding potential nodes that have the low estimated cost value and will not expand potential nodes that have a high estimated cost value.

After propagating the state space with potential nodes, however, the system 100 must determine which of the potential nodes corresponds to a comfortable node. Node expansion based on the safety predicate (e.g., proving stage of node expansion) corresponds to expanding nodes in search of a safe node so that the system 100 may mark ancestor nodes as comfortable nodes. The system 100 may focus the proving stage on proving that potential nodes having the low estimated cost value are safe.

As the system 100 does not know how much processing time is required to prove that a potential node is safe and/or that it is even possible to prove that a potential node is safe, the system 100 may limit the exploration stage and the proving stage to a stage expansion budget (e.g., number of nodes to expand). Thus, the proving stage ends when the potential node is determined to be a comfortable node (e.g., a safe node is identified) or when the stage expansion budget is exhausted.

If the proving stage is successful, the system 100 may reset the stage expansion budget to the original value and mark corresponding potential nodes as comfortable nodes, storing this information for the future. If the proving stage is unsuccessful (e.g., no comfortable descendant node is identified), the system 100 may repeat the exploration stage and the proving stage using a larger stage expansion budget (e.g., double the stage expansion budget). This prevents the system 100 from consuming too much time trying to prove that a potential node is safe, instead the system 100 identifies alternative potential nodes. When the overall time budget is exhausted (e.g., transition time period ends), the system 100 may select from the identified comfortable nodes and/or remain in the current node.

In some examples, the system 100 may vary an amount of processing power available for the proving stage relative to the exploration stage. For example, the system 100 may initially provide an equal amount of processing power for both the exploration stage (e.g., identifying potential nodes) and the proving stage (e.g., determining that the potential nodes are comfortable nodes). However, if a safe node is not identified within a certain period of time, the system 100 may increase the amount of processing power available for the proving stage relative to the exploration stage. Thus, instead of dividing the processing power 50:50 (e.g., 50% directed to the proving stage and 50% directed to the exploration stage), the system 100 may divide the processing power 75:25 (e.g., 75% directed to the proving stage and 25% directed to the exploration stage). Once a safe node is identified, the system 100 may devote all of the processing power to the exploration stage, although the disclosure is not limited thereto.

As illustrated in FIG. 10, the system 100 may determine (1010) potential nodes and apply (1012) a 1:1 ratio of processing power for node expansion based on the safety predicate (e.g., proving stage) relative to node expansion based on the cost function (e.g., exploration stage). For example, the system 100 may split the processing power between the two, with 50% of the processing power directed to performing node expansion to identify potential nodes and 50% of the processing power directed to performing node expansion to identify safe nodes.

The system 100 may determine (1014) whether a safe node is identified and, if not, may determine (1016) whether a duration of time has elapsed. If the duration of time has not elapsed, the system 100 may loop to step 1014 and continue performing node expansion using the 50:50 ratio.

If the duration of time has elapsed, however, the system 100 may increase (1018) the ratio of the processing power for node expansion based on the safety predicate relative to node expansion based on the cost function. For example, the system 100 may distribute the processing power such that 75% of the processing power is directed to node expansion based on the safety predicate (e.g., identifying the safe nodes) and only 25% of the processing power is directed to node expansion based on the cost function (e.g., identifying the potential nodes). The system 100 may then loop to step 1014 and continue performing node expansion using the 75:25 ratio. If a safe node is not determined and the duration of time elapses again, the system 100 may repeat step 1018 to further increase the amount of processing power directed to performing node expansion based on the safety predicate.

Once a safe node is identified, the system 100 may apply (1020) all processing power for performing node expansion based on the cost function. The system 100 may determine (1022) whether a target node exists that has a safe ancestor (e.g., identifies a potential node with a low estimated cost value that is a descendant of a comfortable node), and if not, may determine (1024) whether a duration of time has elapsed. If the duration of time has not elapsed, the system 100 may loop to step 1022 and continue performing node expansion based on the cost function. If the duration of time has elapsed, the system 100 may increase (1026) the stage expansion budget and loop to step 1012 and repeat steps 1012-1024 to identify alternative potential node(s)/safe node(s).

If the system 100 determines that a target node exists that has a safe ancestor, the system 100 may determine (1028) an action corresponding to the target node. For example, the system 100 may select between multiple comfortable nodes based on a cost function f(n) value, a distance-to-safety function value d_{safe}(n), and/or the like, and may determine an action corresponding to the selected comfortable node.

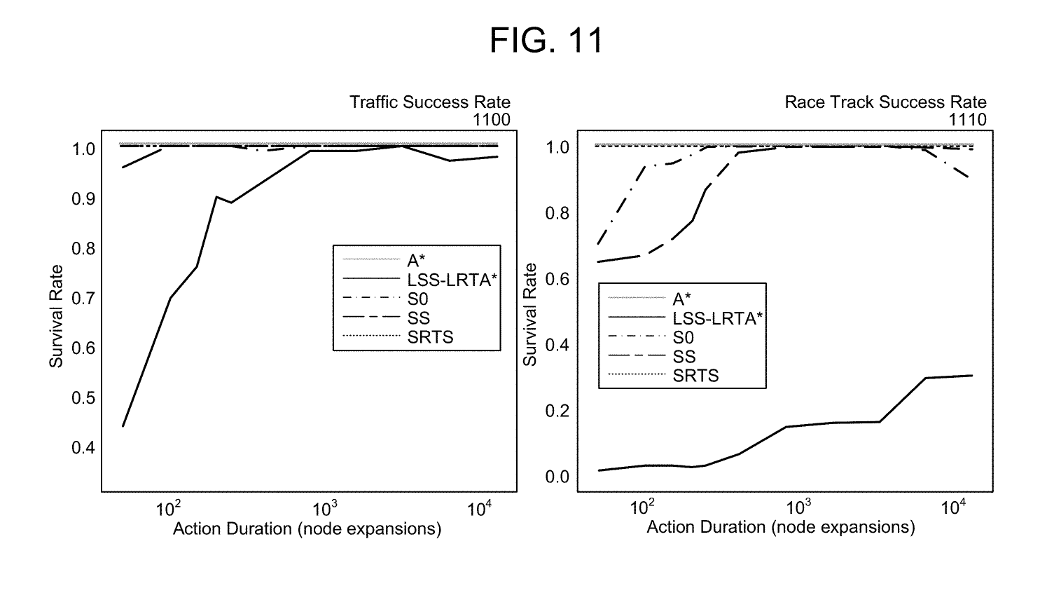

FIG. 11 illustrates examples of success rates for different algorithms according to embodiments of the present disclosure. In some examples, improving the system's ability to reach a goal prioritizes safety and therefore may result in an increased survival rate. As illustrated in FIG. 11, a search algorithm of the system 100 (e.g., safe real time search (SRTS)) is compared to other algorithms based on a survival rate in different scenarios. The other search algorithms include a benchmark algorithm (e.g., A*), which is an offline search algorithm that determines ideal solutions without real-time processing constraints, a Local Search Space Learning Real-Time A* (LSS-LRTA*) algorithm that operates in real-time and prioritizes efficiency without regard to safety, a first modification of the LSS-LRTA* algorithm (e.g., simple search (SS)) that adds a first safety constraint to the LSS-LRTA* algorithm, and a second modification of the LSS-LRTA* algorithm (e.g., S0) that adds a second safety constraint to LSS-LRTA*.

In a first scenario (e.g., traffic scenario), the different search algorithms are tested in an environment with changing conditions and designated safe areas. As illustrated in traffic success rate 1100, the LSS-LRTA* algorithm has a low survival rate and slowly improves as a number of node expansions increases (e.g., more lookahead data), the SS algorithm has a high survival rate and improves towards 1.0 (100%), the S0 algorithm is near 100% for all action duration, and the SRTS algorithm is near the benchmark algorithm A* with a 100% survival rate.

In a second scenario (e.g., race track scenario), the different search algorithms are tested in an environment with a curving race track, with a safe state corresponding to a velocity of 0 in every direction. As illustrated in race track success rate 1110, the LSS-LRTA* algorithm has a very low survival rate (e.g., <0.2) and slowly improves as a number of node expansions increases (e.g., more lookahead data), the SS algorithm has a medium survival rate (e.g., 0.65) and improves towards 1.0 (100%) with more lookahead data, the S0 algorithm is slightly better (e.g., 0.7) and improves more quickly, while the SRTS algorithm is near the benchmark algorithm A* with a 100% survival rate.

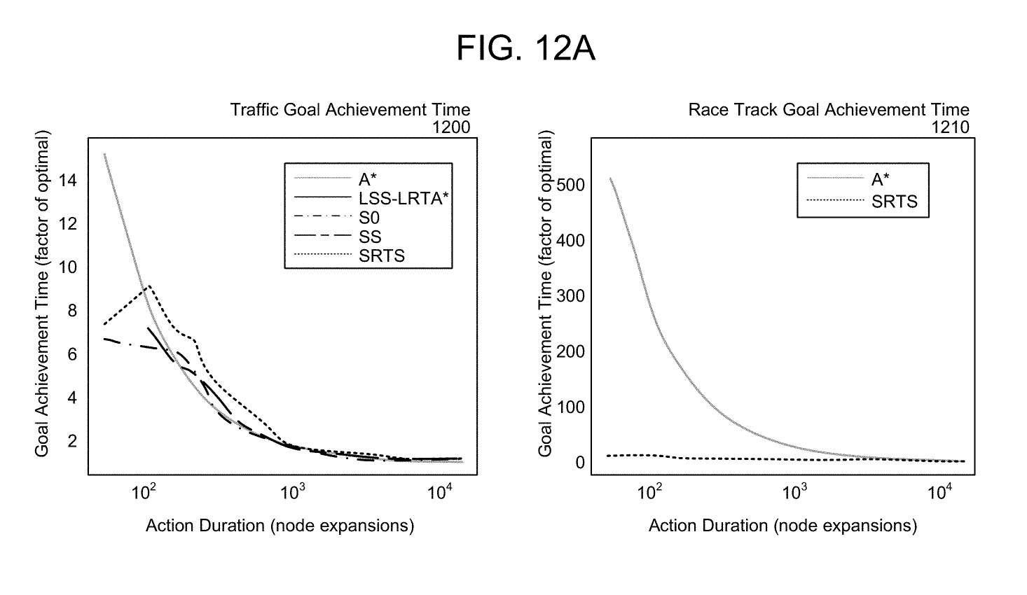

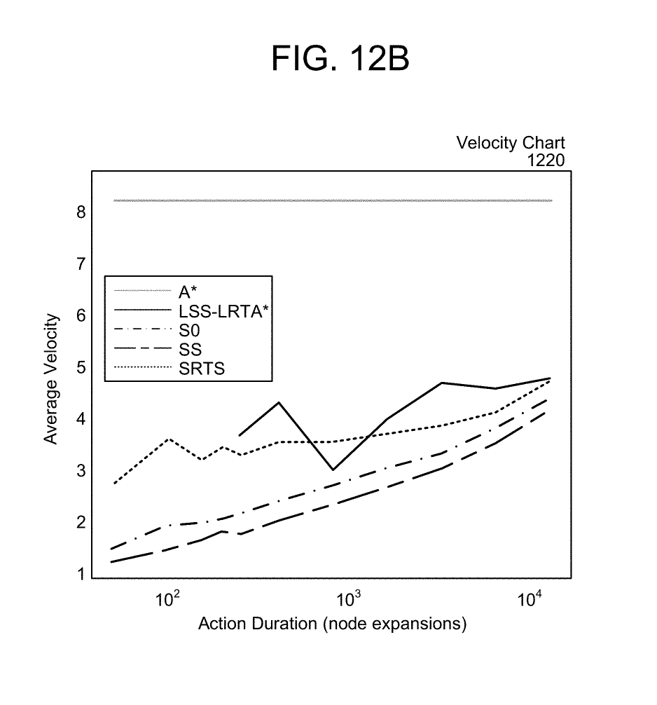

As illustrated in FIG. 11, the SRTS algorithm greatly improves safety relative to the other search algorithms, having a 100% survival rate in both scenarios regardless of the amount of lookahead data available. While FIG. 11 compares survival rates, FIGS. 12A-12B illustrate examples of goal achievement times and average velocity values for different algorithms according to embodiments of the present disclosure.

FIG. 12A illustrates a traffic goal achievement time 1200 that represents the goal achievement time (e.g., factor of optimal) of each of the search algorithms for the first scenario (e.g., traffic scenario) and a race track goal achievement time 1210 that represents the goal achievement time for two of the search algorithms for the second scenario (e.g., race track scenario). As illustrated in the traffic goal achievement time 1200, the SRTS algorithm lags behind the other search algorithms but remains competitive, while maintaining the 100% survival rate illustrated in FIG. 11. However, the race track goal achievement time 1210 illustrates that the SRTS algorithm is faster than the benchmark algorithm A* as the benchmark algorithm A* is unable to perform in real-time, unlike the SRTS algorithm.

Finally, FIG. 12B illustrates a velocity chart 1220 representing average velocities for each of the search algorithms throughout the second scenario (e.g., race track scenario). As illustrated in the velocity chart 1220, the SRTS algorithm maintains higher velocities than the other real-time search algorithms that prioritize safety (e.g., SS and S0), and is competitive with the LSS-LRTA* algorithm, despite having a higher survival rate than all three search algorithms.

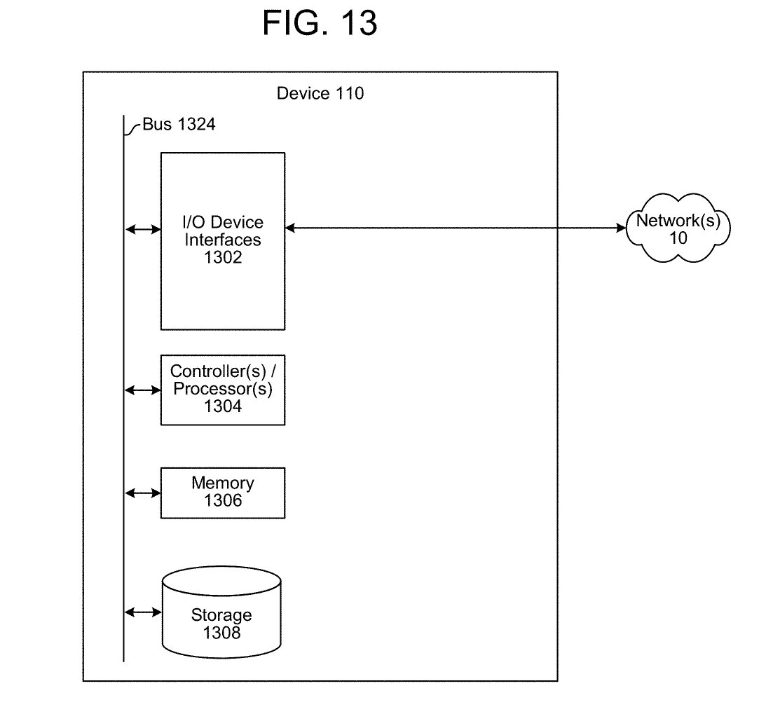

FIG. 13 is a block diagram conceptually illustrating example components of a system according to embodiments of the present disclosure. In operation, the system 100 may include computer-readable and computer-executable instructions that reside on a local device 110 and/or a remote server(s) (not illustrated) without departing from the disclosure.

The device 110 may include an address/data bus 1324 for conveying data among components of the device 110. Each component within the device 110 may also be directly connected to other components in addition to (or instead of) being connected to other components across the bus 1324.

The device 110 may include one or more controllers/processors 1304, which may each include a central processing unit (CPU) for processing data and computer-readable instructions, and a memory 1306 for storing data and instructions. The memory 1306 may include volatile random access memory (RAM), non-volatile read only memory (ROM), non-volatile magnetoresistive (MRAM) and/or other types of memory. The device 110 may also include a data storage component 1308, for storing data and controller/processor-executable instructions. The data storage component 1308 may include one or more non-volatile storage types such as magnetic storage, optical storage, solid-state storage, etc. The device 110 may also be connected to removable or external non-volatile memory and/or storage (such as a removable memory card, memory key drive, networked storage, etc.) through the input/output device interfaces 1302.

Computer instructions for operating the device 110 and its various components may be executed by the controller(s)/processor(s) 1304, using the memory 1306 as temporary “working” storage at runtime. The computer instructions may be stored in a non-transitory manner in non-volatile memory 1306, storage 1308, or an external device. Alternatively, some or all of the executable instructions may be embedded in hardware or firmware in addition to or instead of software.

The device 110 includes input/output device interfaces 1302. A variety of components may be connected through the input/output device interfaces 1302. The input/output device interfaces 1302 may include an interface for an external peripheral device connection such as universal serial bus (USB), FireWire, Thunderbolt or other connection protocol. The input/output device interfaces 1302 may also include a connection to one or more networks 10 via an Ethernet port, a wireless local area network (WLAN) (such as WiFi) radio, Bluetooth, and/or wireless network radio, such as a radio capable of communication with a wireless communication network such as a Long Term Evolution (LTE) network, WiMAX network, 3G network, etc.

The concepts disclosed herein may be applied within a number of different devices and computer systems, including, for example, general-purpose computing systems, autonomous vehicles, specialized systems configured to perform real-time heuristic searches, or the like.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the art should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk and/or other media.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
determining a current state in a state space;
determining a plurality of potential states in the state space, wherein the current state is an ancestor to the plurality of potential states;
determining that a first state of the plurality of potential states is a safe state, wherein the safe state is likely to reach at least one of a plurality of goal states;
determining that a second state of the plurality of potential states is an ancestor to the first state in the state space;
determining a first cost value that indicates an estimated cost to reach the goal state from the second state;
selecting the second state based at least in part on the first cost value; and
performing an action to transition from the current state towards the second state.

2. The computer-implemented method of claim 1, further comprising:
performing state expansion on the plurality of potential states using a first ratio, the first ratio dividing processing time between expanding states based on a cost function and expanding states based on a safety function, wherein the first cost value corresponds to the cost function, and the safety function is used to determine that the first state is likely to reach at least one of the plurality of goal states.

3. The computer-implemented method of claim 1, further comprising:
determining a first portion of the plurality of potential states that corresponds to one or more safe states, wherein each potential state of the one or more safe states is likely to reach at least one of the plurality of goal states, the first portion including the first state;
determining a second portion of the plurality of potential states that corresponds to one or more comfortable states, wherein each potential state of the second portion has at least one descendant state included in the first portion, the second portion including the second state;
determining cost values associated with at least some of the second portion; and
determining that the first cost value is lowest of the cost values.

4. The computer-implemented method of claim 1, further comprising:
determining a first portion of the plurality of potential states that corresponds to one or more safe states, the first portion including the first state;
determining safety values associated with a second portion of the plurality of potential states, wherein the safety values indicate a number of state transitions between each potential state of the second portion and a nearest potential state of the first portion; and
selecting a subset of the second portion based on a threshold value, wherein the safety values associated with the subset are below the threshold value.

5. The computer-implemented method of claim 1, further comprising:
determining that the second state is two or more state transitions away from the current state;
determining that a third state of the plurality of potential states is an ancestor to the second state;
performing a second action to transition from the current state to the third state; and
performing the action to transition from the third state towards the second state.

6. A computer-implemented method comprising:
determining a current state in a state space;
determining a plurality of potential states in the state space, wherein the current state is an ancestor to the plurality of potential states;
determining a first portion of the plurality of potential states that correspond to one or more safe states, wherein each of the one or more safe states is likely to reach at least one of a plurality of goal states;
determining that each potential state of a second portion of the plurality of potential states has at least one descendant state that is included in the first portion, the second portion including a first state of the plurality of potential states;
determining cost values associated with the second portion, wherein a first cost value indicates an estimated cost to reach one of the plurality of goal states from the first state;
determining that the first cost value is lowest of the cost values; and
performing an action to transition from the current state towards the first state.

7. The computer-implemented method of claim 6, further comprising:
performing state expansion on the plurality of potential states using a first ratio, the first ratio dividing processing time between expanding states based on a cost function and expanding states based on a safety function, wherein the cost values correspond to the cost function, and the safety function is used to identify the one or more safe states.

8. The computer-implemented method of claim 6, further comprising:
determining safety values associated with the second portion, wherein the safety values indicate a number of state transitions between each potential state and one of the one or more safe states; and
selecting a subset of the second portion based on a threshold value, wherein the safety values associated with the subset are below the threshold value.

9. The computer-implemented method of claim 6, further comprising:
determining that the first state is two or more state transitions away from the current state;
determining that a second state of the plurality of potential states is an ancestor to the first state;
performing a second action to transition from the current state to the second state; and
performing the action to transition from the second state towards the first state.

10. A computer-implemented method comprising:
determining a current state in a state space;
determining a plurality of potential states in the state space, wherein the current state is an ancestor to the plurality of potential states and the plurality of potential states includes a first state and a second state;
determining cost values associated with a first portion of the plurality of potential states, wherein the first portion includes the first state and a first cost value indicates an estimated cost to reach one of a plurality of goal states from the first state;
determining that the first cost value is lowest of the cost values;
determining that the second state is one of a plurality of safe states, wherein each of the plurality of safe states is likely to reach one of the plurality of goal states;
determining that the second state is an ancestor to the first state in the state space; and
performing an action to transition from the current state towards the second state.

11. The computer-implemented method of claim 10, further comprising:
performing state expansion on the plurality of potential states using a first ratio, the first ratio dividing processing time between expanding states based on a cost function and expanding states based on a safety function, wherein the cost values correspond to the cost function and the safety function is used to identify the plurality of safe sates.

12. The computer-implemented method of claim 10, further comprising:
determining a second portion of the plurality of potential states that corresponds to one or more safe states, the second portion including the second state;
determining the first portion, wherein each potential state of the first portion has at least one descendant state included in the second portion.

13. The computer-implemented method of claim 10, further comprising:
determining safety values associated with the plurality of potential states, wherein the safety values indicate a number of state transitions between each potential state and one of the plurality of safe states; and
selecting the first portion based on a threshold value, wherein the safety values associated with the first portion are below the threshold value.

14. The computer-implemented method of claim 10, further comprising:
determining that the second state is two or more state transitions away from the current state;
determining that a third state of the plurality of potential states is an ancestor to the second state;
performing a second action to transition from the current state to the third state; and
performing the action to transition from the third state towards the second state.

15. A computer-implemented method comprising:
determining a current state in a state space;
determining a plurality of potential states in the state space, wherein the current state is an ancestor to the plurality of potential states and the plurality of potential states includes a first state;
performing first state expansion using a first ratio, the first ratio dividing processing time between expanding potential states based on a cost function and expanding potential states based on a safety function, wherein the cost function is used to determine a first cost value indicating an estimated cost to reach one of a plurality of goal states from the first state, and the safety function is used to determine that at least one descendant of the first state is a safe state that is likely to reach one of the plurality of goal states;
selecting, based on the first cost value, the first state; and
performing an action to transition from the current state towards the first state.

16. The computer-implemented method of claim 15, further comprising:
identifying, during the first state expansion, a first portion of the plurality of potential states;
determining that no potential state of the first portion has a descendant state that is likely to reach one of the plurality of goal states; and
performing second state expansion using a second ratio, wherein the second ratio increases the processing time associated with expanding states based on the safety function.

17. The computer-implemented method of claim 15, further comprising:
identifying, during the first state expansion, a first portion of the plurality of potential states;
determining that at least one potential state of the first portion has a descendant state that is likely to reach one of the plurality of goal states; and
performing second state expansion using a second ratio, wherein the second ratio increases the processing time associated with expanding states based on the cost function.

18. The computer-implemented method of claim 15, further comprising:
determining a first portion of the plurality of potential states that corresponds to one or more safe states, the first portion including a second state of the plurality of potential states; and
determining that each potential state of a second portion of the plurality of potential states has at least one descendant state that is included in the first portion.

19. The computer-implemented method of claim 15, further comprising:
determining safety values associated with the plurality of potential states, wherein the safety values are determined using a safety function and indicate a number of state transitions between each potential state and one of a plurality of safe states; and
selecting a first portion of the potential states based on a threshold value, wherein safety values associated with the first portion are below the threshold value.

20. The computer-implemented method of claim 15, further comprising:
determining that the first state is two or more state transitions away from the current state;
determining that a second state of the plurality of potential states is an ancestor to the first state;
performing a second action to transition from the current state to the second state; and
performing the action to transition from the second state towards the first state.

21. A computer-implemented method comprising:
determining a current state in a state space;
determining that a first potential state is a descendant of the current state;
determining, based on a goal predicate, that the first potential state does not correspond to one of a plurality of goal states;
determining, based on a safety predicate, that the first potential state corresponds to one of a plurality of safe states, wherein each of the plurality of safe states is likely to reach one of the plurality of goal states;
determining a first cost value corresponding to the first potential state, the first cost value indicating an estimated cost to reach one of the plurality of goal states from the first potential state;
selecting the first potential state based on the first cost value and the first potential state corresponding to one of the plurality of safe states; and
performing an action to transition from the current state towards the first potential state.
